(19) United States
(12) Patent Application Publication
(10) Pub. No.: US 2023/0051226 A1
(43) Pub. Date: Feb. 16, 2023

(54) FLOW CELL IMAGING SYSTEMS AND METHODS, AND FLOW CELLS AND OTHER SUBSTRATES FOR USE IN THE SAME

(71) Applicant: MGI Tech Co., Ltd., Shenzhen (CN)

(72) Inventors: Paul Lundquist, Oakland, CA (US); Craig Ulrich, San Jose, CA (US); Razvan Chirita, Redwood City, CA (US); Andriy Tspuryk, San Jose, CA (US); Chintang Yen, San Jose, CA (US)

(21) Appl. No.: 17/879,075

(22) Filed: Aug. 2, 2022

Related U.S. Application Data
(60) Provisional application No. 63/231,488, filed on Aug. 10, 2021.

(51) Int. Cl. G01N 21/03; G01N 21/05

(52) U.S. Cl. CPC G01N 21/0303; G01N 21/05

(57) ABSTRACT

Double sided flow cell and other substrate imaging systems, such as imaging systems used in nucleic acid sequencing and similar processes. In one example, the imaging system includes a flipper to facilitate imaging different surfaces of the flow cell or other substrate. In another example, the imaging system includes two optical systems for imaging different surfaces of the flow cell or other substrate. In another example, the imaging system is an immersion system. In these and other examples, the system may include an auto-focus sub-system configured to accurately focus the optics on one surface of the double sided flow cell without interference from the other surface of the flow cell.

### RELATED APPLICATIONS

This application claims priority to and the benefit of the filing date of U.S. provisional patent application Ser. No. 63/231,488 filed Aug. 10, 2021, the entire contents of which are hereby incorporated by this reference.

### RELATED FIELDS

This patent relates to flow cell and other substrate imaging systems, such as imaging systems used in nucleic acid sequencing and similar processes.

### BACKGROUND

Many current nucleic acid sequencing systems and processes are resource intensive, requiring, among other things, a significant amount of reagents and a significant amount of time. Massively parallel systems and processes have been developed in an attempt to more efficiently use resources; however, there remains room for improvement.

### SUMMARY

In this patent we describe several examples of flow cells and other substrates, and systems and methods for imaging those flow cells and other substrates, in which two sides of the flow cell or other substrate have analyte for analysis. The flow cells, other substrates, and systems and methods for imaging those flow cells and other substrates described in this patent may facilitate more efficient use of resources, such as minimizing use of reagents and improving the speed at which samples can be processed.

In one example, an imaging system includes: a stage configured to hold a carrier configured to receive an analyte; a light source configured to illuminate the analyte with an optical beam, wherein the optical beam is characterized by an optical path; a detector configured to detect light; and a lens system configured to focus light from the analyte on the detector after the optical beam illuminates the analyte, in which: the lens system is characterized by an optical axis; the optical beam is configured to propagate through the lens system to illuminate the analyte; and the optical path of the optical beam incident on the carrier is not parallel with the optical axis of the lens system.

The imaging system may also include a controller configured change a distance between the carrier and the lens system, to focus light from the analyte on the detector.

The imaging system may also include one or more processors configured to:

calculate a first light intensity based on light detected by a first block of pixels of the detector; calculate a second light intensity based on light detected by a second block of pixels of the detector; compare the first light intensity to the second light intensity to generate a focus error signal; and control movement of the lens system in relation to the carrier based on the focus error signal.

The detector may be an array detector configured to focus on a spot of light incident on the detector.

The array detector may be a one-dimensional array.

The carrier may be a flow cell, in which the flow cell includes a first analyte receiving surface and a second analyte receiving surface separated by a width.

The depth of focus of the lens system may be smaller than the width.

The stage may be configured to move so that the lens system focuses light from the first analyte receiving surface on the detector and focuses light from the second analyte receiving surface on the detector, though not simultaneously.

The optical beam may be defined by a beam width; the beam width may be measured at the carrier; and the beam width may be equal to or less than 2 mm and/or equal to or greater than 10 microns.

The lens system may include an immersion objective with a distal lens surface configured to be immersed in a fluid.

The imaging system may be configured so that: (a) when in a first configuration, the system is configured to image emitted radiation from analytes associated with the first analyte receiving surface, with the distal lens surface spaced by a first vertical distance from the first analyte receiving surface, the first vertical distance including a fluid segment and a substrate segment; (b) when in a second configuration, the system is configured to image emitted radiation from analytes associated with the second analyte receiving surface, with the distal lens surface spaced by a second vertical distance from the second analyte receiving surface, the second vertical distance including fluid segments and a substrate segment; and (c) such that the first vertical distance is substantially the same as the second vertical distance, and the fluid segment of the first vertical distance is substantially the same as the fluid segments of the second vertical distance.

The immersion objective may be at least partially immersed in a reservoir on top of the first analyte receiving surface such that there is no air gap between the distal lens surface and the first analyte receiving surface.

The imaging system may also include an x-y translation stage configured to translate one of the immersion objective or the flow cell relative to the other of the immersion objective or the flow cell during imaging and while the immersion objective is at least partially immersed in the reservoir.

The fluid in the reservoir may have substantially the same index of refraction as a fluid in a fluid passageway of the flow cell between the first and second analyte receiving surfaces.

In another example, an imaging system includes: (a) a flow cell, the flow cell having a first substrate including a first surface, a second substrate including a second surface, and a fluid passageway between the first surface and the second surface; (b) an imager, the imager including an immersion objective, the immersion objective having a distal lens surface, the immersion objective at least partially immersed in a fluid; and (c) when in a first configuration, the system is configured to image emitted radiation from analytes associated with the first surface, with the distal lens surface spaced by a first vertical distance from the first surface, the first vertical distance including a fluid segment and a substrate segment; (d) when in a second configuration, the system is configured to image emitted radiation from analytes associated with the second surface, with the distal lens surface spaced by a second vertical distance from the second surface, the second vertical distance including fluid segments and a substrate segment; and (e) in which the first vertical distance is substantially the same as the second vertical distance, and in which the fluid segment of the first vertical distance is substantially the same as the fluid segments of the second vertical distance.

The system may further include a z-translation stage configured to vertically translate one of the immersion objective or the flow cell relative to the other of the immersion objective or the flow cell.

The system may be configured to change from the first configuration to the second configuration by vertically translating one of the immersion objective or the flow cell relative to the other of the immersion objective or the flow cell by a distance substantially equal to a height of the fluid passageway.

The system may further include an autofocus sub-system, in which the auto-focus sub-system is configured to focus on the first surface when the system is in the first configuration, and in which the auto-focus sub-system is configured to focus on the second surface when the system is in the second configuration.

The first surface may be an interior surface of the first substrate, the second surface may be an interior surface of the second substrate, and the first and second surfaces may face each other across the fluid passageway.

The system may further include a radiation source configured to stimulate emitted radiation from the analytes associated with the first and second surfaces.

The first substrate may be substantially transparent to radiation from the radiation source and substantially transparent to the emitted radiation from the analytes associated with the first and second surfaces.

The immersion objective may be at least partially immersed in a reservoir on top of the first substrate such that there is no air gap between the distal lens surface and the first surface of the flow cell.

The system may further include an x-y translation stage configured to translate one of the immersion objective or the flow cell relative to the other of the immersion objective or the flow cell during imaging and while the immersion objective is at least partially immersed in the reservoir.

The fluid in the reservoir may have substantially the same index of refraction as a fluid in the fluid passageway.

In another example, an imaging system includes: (a) a double-sided substrate including a first surface, and a second surface; (b) an imager; (c) a flipper, the flipper configured to flip the substrate between a first orientation and a second orientation, in which, when the substrate is in the first orientation, the system is configured to image emitted radiation from analytes associated with the first surface, and, in which, when the substrate is in the second orientation, the system is configured to image emitted radiation from analytes associated with the second surface.

The double-sided substrate may be a flow cell with a fluid passageway located between the first surface and the second surface

The flow cell may include a first substrate and a second substrate, the first surface being an interior surface of the first substrate, the second surface being an interior surface of the second substrate, the first and second surfaces facing each other across the fluid passageway.

The first substrate may include a first thickness, the second substrate may include a second thickness, such that the first and second thicknesses are substantially the same.

The system may further include a radiation source configured to stimulate emitted radiation from the analytes associated with the first and second surfaces.

The first and second substrates may be substantially transparent to radiation from the radiation source and substantially transparent to the emitted radiation from the analytes associated with the first and second surfaces.

The double-sided substrate may include a first substrate joined to a second substrate, with the first and second surfaces being outer surfaces of the double-sided substrate.

The system may further include an autofocus sub-system, in which the auto-focus sub-system is configured to focus on the first surface when the double-sided substrate is in the first orientation, and in which the auto-focus sub-system is configured to focus on the second surface when the double-sided substrate is in the second orientation.

The imaging system may further include an imaging station, at least one additional station, and a transport device, the transport device configured to move the double-sided substrate between the stations.

The transport device may include the flipper.

In another example, an imaging system includes: (a) a double-sided substrate, the double-sided substrate having a first surface and a second surface; (b) a first imager, the first imager configured to image emitted radiation from analytes associated with the first surface; and (c) a second imager, the second imager configured to image emitted radiation from analytes associated with the second surface.

The double-sided substrate may be a flow cell.

The flow cell may have a first substrate and a second substrate, the first surface being an interior surface of the first substrate, the second surface being an interior surface of the second substrate, the first and second surfaces facing each other across a fluid passageway.

The imaging system may further include a radiation source, the radiation source configured to simulate emission of radiation from the analytes associated with the first and second surfaces.

The radiation source may be configured to simultaneously stimulate emission of radiation from analytes associated with the first and second surfaces.

The radiation source may include a single laser beam configured to simultaneously stimulate emission of radiation from analytes associated with the first and second surfaces.

The imaging system may be configured to simultaneously image emitted radiation from analytes associated with the first surface using the first imager and emitted radiation from analytes associated with the second surface using the second imager.

The first imager may have a first objective with a first optical axis, the second image may have a second objective with a second optical axis, and the system is may be configured to position the flow cell between the first and second objectives.

The flow cell may be positioned between the first and second objectives, the first objective facing the first substrate and the second objective facing the second substrate.

The first and second optical axes may be co-linear optical axes.

In another example, a double-sided substrate includes a first planar surface, an array of analyte binding sites on the first planar surface, a second planar surface, and an array of analyte binding sites on the second planar surface.

The first planar surface may be an outer surface of a first substrate and the second planar surface may be an outer surface of a second substrate, the first and second substrates joined together at inner surfaces.

In another example, an imaging system includes: a stage configured to hold a carrier having an analyte; a light source configured to illuminate the analyte with an optical beam, in which: the carrier is configured to be attached with the stage, while the analyte is illuminated by the optical beam; and the optical beam is characterized by an optical path; a detector configured to detect light; and a lens system configured to focus light from the analyte on the detector, after the optical beam illuminates the analyte, in which: the lens system is characterized by an optical axis; the optical beam is configured to propagate through the lens system to illuminate the analyte; and the optical path of the optical beam incident on the carrier is not parallel with the optical axis of the lens system.

The imaging system may further include a controller configured change a distance between the carrier and the lens system, to focus light from the analyte on the detector.

The system may further include one or more processors configured to: calculate a first light intensity based on light detected by a first block of pixels of the detector; calculate a second light intensity based on light detected by a second block of pixels of the detector; compare the first light intensity to the second light intensity to generate a focus error signal; and control movement of the lens system in relation to the carrier based on the focus error signal.

The carrier may be a flow cell.

The detector may be an array detector configured to focus on a spot of light incident on the detector.

The array detector may be a one-dimensional array.

The carrier may include a first surface and a second surface; and the first surface may be separated from the second surface by a width.

A depth of focus of the lens system may be smaller than the width separating the first surface from the second surface of the carrier.

The analyte may include a first analyte attached to the first surface and a second analyte is attached to the second surface.

The stage may be configured to move so that the lens system focuses light from the first analyte on the detector and focuses light from the second analyte on the detector, though not simultaneously.

The optical beam may be defined by a beam width measured at the carrier, and the beam width may be equal to or less than 2.0 mm and/or equal to or greater than 10 microns.

In another example, an imaging method may include: attaching a carrier to a stage, the carrier including an analyte; villuminating the analyte with a light source by transmitting an optical beam of the light source through a lens system to the analyte, in which: the optical beam is characterized by an optical path; the lens system is characterized by an optical axis; and the optical path of the optical beam incident on the carrier is not parallel with the optical axis of the lens system; focusing light from the analyte to a detector using the lens system; and detecting light from the analyte with the detector.

The imaging method may further include controlling movement of the lens system in relation to the carrier, in a direction parallel with the optical axis of the lens system, to focus light from the analyte on the detector.

Controlling movement of the lens system in relation to the carrier may include: calculating a first light intensity, in which the first light intensity is calculated based on light detected by a first block of pixels of the detector; calculating a second light intensity, in which the second light intensity is calculated based on light detected by a second block of pixels of the detector; comparing the first light intensity to the second light intensity to generate a focus error signal; and controlling movement of the lens system in relation to the carrier based on the focus error signal.

In another example, an imaging method includes: defining a first block of pixels of a detector; defining a second block of pixels of the detector; illuminating an analyte with an off-axis optical beam; detecting light from the analyte using the detector, after light from the analyte passes through a lens system; calculating a first light intensity, in which the first light intensity is calculated based on light detected by the first block of pixels; calculating a second light intensity, in which the second light intensity is calculated based on light detected by the second block of pixels; comparing the first light intensity to the second light intensity to generate a focus error signal; and adjusting a distance between the lens system and the analyte, based on the focus error signal.

### BRIEF DESCRIPTION OF DRAWINGS

FIG. 1a schematically illustrates an example of a flow cell.

FIG. 1b schematically illustrates the flow cell of FIG. 1a in a holder.

FIG. 1c illustrates another example of a flow cell and a holder.

FIG. 1d illustrates the holder of FIG. 1c holding the flow cell of FIG. 1c.

FIG. 1e schematically illustrates another example of a flow cell.

FIG. 2 schematically illustrates an example of an imaging system.

FIG. 3 schematically illustrates another example of an imaging system.

FIG. 4a illustrates a flow cell oriented relative to an objective of an imaging system.

FIG. 4b illustrates the flow cell in a flipped orientation from FIG. 4a.

FIG. 5 schematically illustrates another example of an imaging system.

FIG. 6 illustrates a flow cell located between the two objectives of the imaging system of FIG. 5.

FIGS. 7-18 illustrate another example of an imaging system.

FIG. 19 illustrates another example of a double-sided substrate.

FIG. 20 depicts an embodiment of an auto-focus system.

FIG. 21 illustrates an embodiment of reflections from an off-axis, narrow illumination beam.

FIGS. 22-24 illustrate embodiments of spots from reflections based on different flow cell materials.

FIG. 25 is a montage of images from an embodiment of focusing on two reflection spots.

FIG. 26 is an embodiment of groups of pixels for an auto-focus algorithm.

FIG. 27 depicts a graph of an embodiment of moving a spot across two pixel groups.

FIG. 28 depicts a graph of an embodiment of summation and difference of light from groups of pixels as focus is changed.

FIG. 29 depicts a graph of an embodiment of an auto-focus signal.

FIG. 30 depicts a heat map of surface height of an embodiment of a flow cell.

FIG. 31 depicts a heat map of a thickness of an embodiment of a flow cell.

FIG. 32 depicts a chart of lag time for an embodiment of a detector.

FIGS. 33 and 34 depict charts used to calculate autofocus error during scanning of an embodiment of a surface of a flow cell.

FIG. 35 depicts a series of images of an embodiment of a surface during a focus sweep.

FIG. 36 is chart of an embodiment of a focus score during the focus sweep.

FIG. 37 depicts a series of images of a surface during a focus sweep.

FIG. 38 is a flowchart of an embodiment of a process for imaging a flow cell.

FIG. 39 is a flowchart of an embodiment of a process for an auto focus of a flow cell surface.

FIG. 40 depicts a block diagram of an embodiment of a computer system.

FIGS. 41-43 schematically illustrate another example of an imaging system.

The figures are not all to scale. When appropriate, reference numbers are repeated among the figures to indicate corresponding elements.

### DETAILED DESCRIPTION

### Flow Cell

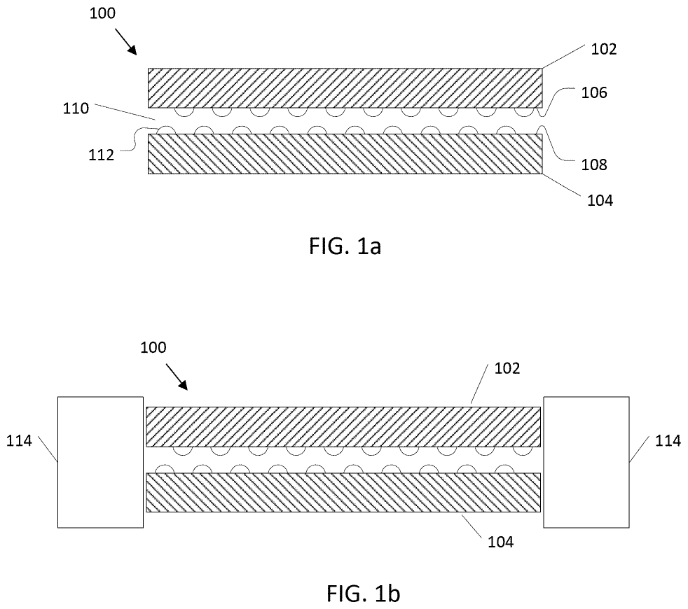

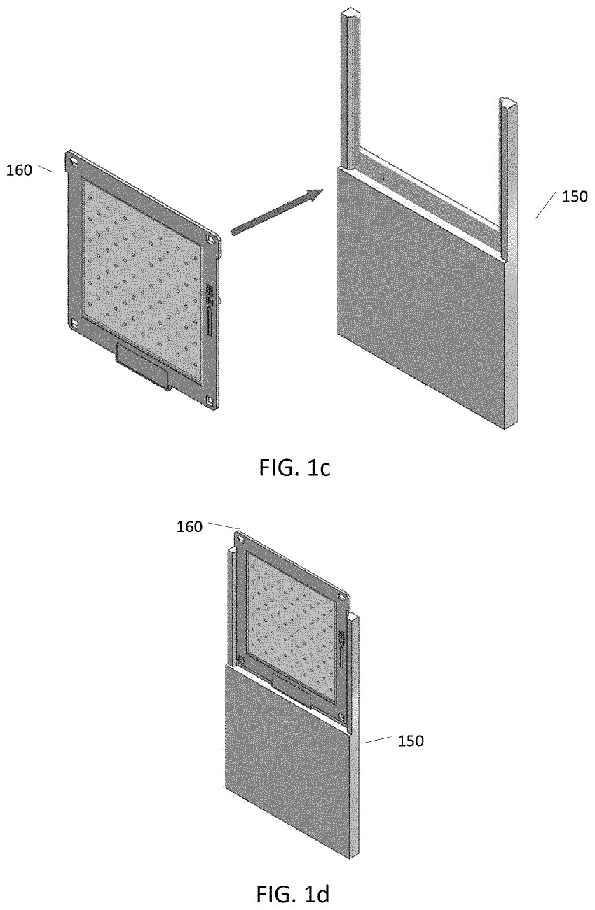

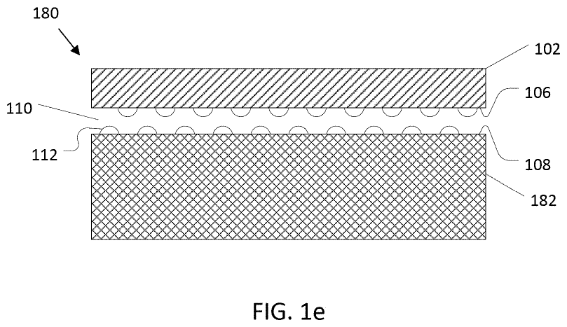

FIG. 1a shows an example of a flow cell 100. Flow cell 100 includes a first substrate 102 and a second substrate 104 positioned so that a first surface 106 of the first substrate 102 faces a second surface 108 of the second substrate 104. The surfaces 106, 108 are spaced apart, defining a fluid passageway 100 between those surfaces.

Surfaces 106, 108 are configured to receive analyte 112 for analysis. Analyte 112 may be nucleic acid material such as DNA or RNA to be sequenced, or other biological or non-biological/synthetic material to be analyzed. In one specific example, analyte 112 may be DNA nanoballs or other discrete nucleic acid samples to be sequenced or otherwise analyzed. Analyte 112 may be arranged in a spaced array of discrete units partially or entirely across the first and second surfaces 106, 108. Although not shown in the figures, the surfaces 106, 108 may include an array of discrete attachment sites spaced apart from one another where individual analyte units 112 may be held spaced apart from adjacent analyte units 112. Although only a few discrete analyte 112 sites are shown in the figures for illustrative purposes, it should be understood that arrays may include up to millions or billions of discrete analyte sites, spaced at pitches that may be on the order of tens or hundreds of nanometers.

Flow cell 100 is configured for reagents and other fluids to be flowed through fluid passageway 110 in order to perform sequencing or other reactions on the analyte 112. In one example, during sequencing reactions, fluorescently-tagged molecules may selectively bind to some of the analyte 112. As discussed in greater detail below, an optical imaging system may be used to stimulate and detect fluorescent emissions from tagged analyte 112 in order to generate sequencing or other data associated with the analyte 112.

The substrates 102, 104 of the FIG. 1a flow cell 100 may be made of a material or materials that is substantially transparent to radiation wavelength(s) used to stimulate emissions from tagged analyte 112, and also substantially transparent to radiation wavelength(s) of the emissions from tagged analyte 112 sites. The substrates 102, 104 may also be of a material or materials that does not generate substantial emissions in the wavelength range(s) of the stimulated emissions from tagged analyte 112 sites (e.g. via fluorescence of the substrate material itself or by inelastic photon scattering processes like Raman Scatter). As used in this paragraph, “substantially” and “substantial” refers to levels that would interfere with stimulation and/or detection of the emissions from tagged analyte 112 sites. In one implementation, substrates 102, 104 are both glass or another suitably optically transparent material.

In this example, the analyte 112 on the interior surfaces of substrate 102 and 104 (e.g. DNA nanoballs or other discrete nucleic acid analytes) are bound to discrete sites arranged in arrays on the interior surfaces of the substrates 102 and 104. These binding sites may be fabricated by well-known lithography tools, such as 248-nm KrF (krypton fluoride), 193-nm ArF (argon-fluoride) lithography systems, or e-beam lithography systems. The arrays are typically separated with spaces between each other in ultra-high density, high density, medium density, or low density. At ultra-high density, separation is less than 250 nm. At high density, separation is 300 to 350 nm. At medium density, separation is 400 nm to 500 nm. At low density, separation is 500 nm or more. In some implementations (for example, some low density implementations) 2-dimensional patterning with photoresist is sufficient to sequester DNA nanoballs or other discrete nucleic acid samples. In some implementations (for example, some medium, high, or ultra-high density implementations), to reduce risk that discrete samples will not remain in single locations, smaller samples may be required, which may require 3-dimensional patterning for more efficient capturing of fluorescence from tagged DNA nanoballs or other tagged nucleic acid samples. In such implementations, 3-dimensional patterned well nanostructures can be developed by non-binding material as a well wall and binding material for the well bottom surface for sequestering DNA nanoballs.

The FIG. 1a flow cell 100 is optically symmetric. Both substrates 102, 104 are of substantially the same thickness, material, shape, and otherwise identical or nearly identical.

FIG. 1b shows the flow cell 100 held by a holder 114. The holder 114 contacts the flow cell 100 at the flow cell's edges/perimeter so that the flow cell 100 can be imaged through both substrates 102, 104 without interference by the holder 114.

FIGS. 1c and 1d show another example of a holder 150 for holding a flow cell 160. As shown in FIGS. 1c and 1d, the holder 150 holds the flow cell 160 at its edges, leaving the flow cell's substrates un-covered so that they can be imaged through.

FIG. 1e shows another example of a flow cell 180. Flow cell 180 includes a first substrate 102 with a surface 106 configured to receive an analyte 112 for analysis, and a second substrate 182 with a surface 108 configured to receive an analyte 112 for analysis. Unlike the flow cell 100 of FIG. 1a, the flow cell 180 of FIG. 1e is not optically symmetric. In FIG. 1e, substrate 102 is optically transparent and substrate 182 is of a different non-optically transparent material, and is also thicker. In the particular example of FIG. 1e, substrate 102 is SiO₂ and substrate 108 is Si.

### Flow Cell—Example Methods of Manufacture

In general, the substrates with attachment site arrays may be diced from a full 8 inch-wafer, such as by laser dicing or saw dicing. For glass substrates, such as substrates 102, 104 of flow cell 100 in FIG. 1a, the dicing tolerance from the full wafer may be +/−50 um in both x and y-planar directions. For the symmetrical flow cell 100 of FIG. 1a, the diced bottom glass substrate 104 may have four drilled holes as fluidic inlet and outlet ports and two top and bottom trenches, whereas, the diced top glass substrate 102 will have no drilled holes and trenches.

The two substrates of flow cell 100 may be supported by an adhesive material, such as UV/Visible light curable adhesives mixing with polystyrene beads with specific size or Pressure-sensitive adhesive (PSA) with specific thickness to define as spacing structure. The UV/Visible light curable adhesives can be dispensed on one of the glass surface as multiple adhesive dots or lines or specific channel features and bond the upper and lower glass substrates 102, 104 together. Another approach can be using pre-cut PSA tape with define channel shapes to bond the two glass substrates 102, 104.

During flow call 100 fabrication, the bottom glass substrate may be held by a vacuum pre-assembly chuck, which is aligned by alignment pins, and the UV adhesive may be dispensed using an automatic adhesive dispensing system on the surface 108 of bottom glass substrate 104. The designed dispensing program may be executed to dispense the adhesive with beads in a desired pattern on the surface. The upper glass substrate 102 may be picked up by a vacuum weight with ball-shaped pins and placed onto the adhesive pattern by aligning the pre-assembly chuck holes, to ensure full contact with adhesive on the lower glass substrate 104. A uniform downward force from the weight may be applied on the glass substrates until the adhesive is fully cured by exposing to UV light. The curing time may vary depending on the cure requirements of the adhesives. The weight applied on the glass substrates 102, 104 may be a uniform load to ensure the flow cell fluid passageway gap uniformity, whereas the size of spacer used may define the specific flow cell gap or spacing. In general, the flow cell gap height may be defined as the distance between the top glass surface and the bottom glass surface measured perpendicular to the plane of the flow cell. The gap height, in one example, may be about 50 um with tolerance of +/−5 um.

In another example, flow cell fabrication may use pre-cut channel pressure sensitive adhesive (PSA) tape as a bonding material. The thickness of PSA tape may acts as a mechanical spacer to define the flow cell gap height. The pre-cut channel PSA tape may be applied to the surface 106 of top glass substrate 102. Next, the upper glass substrate 102 with bonded pre-cut channel PSA tape may be picked up by a vacuum weight and placed on the surface 108 of bottom glass substrate 104. The weight may stay on the glass substrates for a desired time to ensure the glass substrates are fully contact with the PSA tape.

In both fabrication approaches described above, there may be 100 to 200 um placement tolerance between the top glass substrate 102 and the bottom substrate 104 in the flow cell 100.

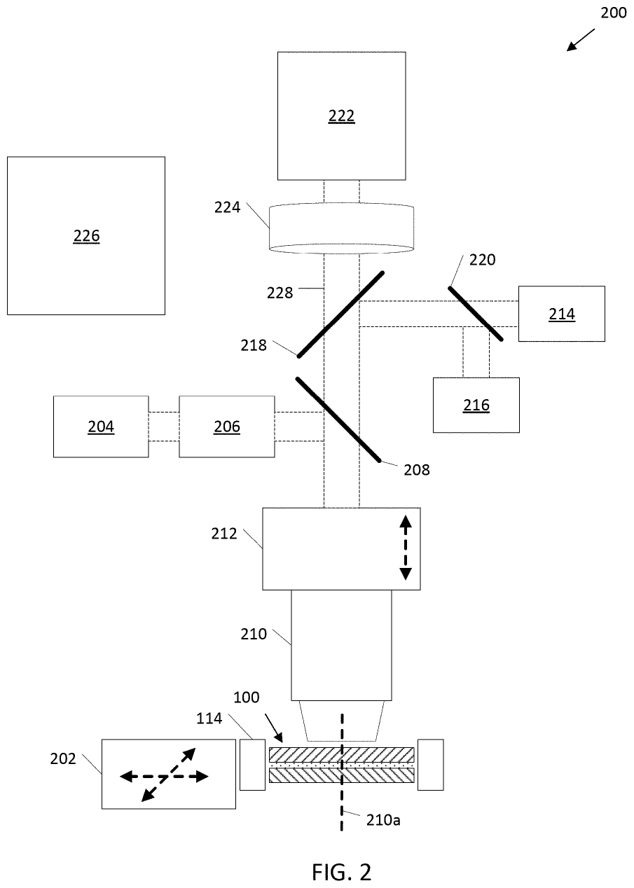

### FIG. 2 Imaging System

FIG. 2 schematically illustrates an example of an optical imaging system 200. In the example of FIG. 2, radiation from a radiation source 204 is directed to flow cell 100 to stimulate emissions from tags associated with some of the analyte sites 112. The emissions are imaged by detector 222. Optical imaging system 200 is controlled by controller 226, which may be one or more computers or other devices configured to control the various components of the system 200 and to process data collected by the various components of the system.

In the example of FIG. 2, radiation source 204 is a laser configured to emit laser light that stimulates fluorescent emissions by fluorescently-tagged analyte 112 in the flow cell 100. The laser light from laser 204 passes through conditioning optics 206, directing optics 208, and objective 210 to the flow cell 100. Directing optics 208 may be a dichroic beam splitter or other optical component configured to reflect light wavelengths from radiation source 204 while allowing other light wavelengths (including the fluorescent emissions from analyte 112) to pass through the directing optics 208 along the optical path 228 to the detector 222. Although FIG. 2 only shows a single radiation source 204 for stimulating fluorescent emissions by analyte 112, additional radiation sources operating at different wavelengths may be included, in conjunction with additional conditioning and directing optics for those additional radiation sources.

X-Y stage 202 translates the flow cell 100 in x and y directions (perpendicular to the optical axis 210a of objective 210), allowing the laser beam from radiation source 204 to be scanned across the flow cell 100.

In FIG. 2, detector 222 images fluorescent emissions from analyte 112. Detector 222 may be any suitable camera or other device configured to image stimulated emissions from tags associated with analyte 112. Detector 222 may include a charge coupled device image sensor (CCD), a complementary metal oxide semiconductor image sensor (CMOS), or other suitable image sensor. Detector 222 may be a time delay and integration (TDI) detector.

In the example of FIG. 2, the laser light directed to the flow cell can simultaneously stimulate fluorescent emissions from tagged analyte associated with both surfaces 106, 108 of the flow cell 100. The imaging system 200 includes an autofocus sub-system that facilitates imaging fluorescent emissions from analyte on one surface of the flow cell 100 without undue interference by fluorescent emissions from analyte on the other surface of the flow cell 100. In the example of FIG. 2, the autofocus sub-system includes a radiation source 214 (e.g. an infra-red laser), directing optics 218, 220, and a detector 216 that receives light reflected from the radiation source 214 by surfaces of the flow cell 100. The controller 226 receives data from the detector 216, and based on that data, actuates z-translation stage 212 to translate the objective 210 in the z direction, along the optical axis of the objective 210a.

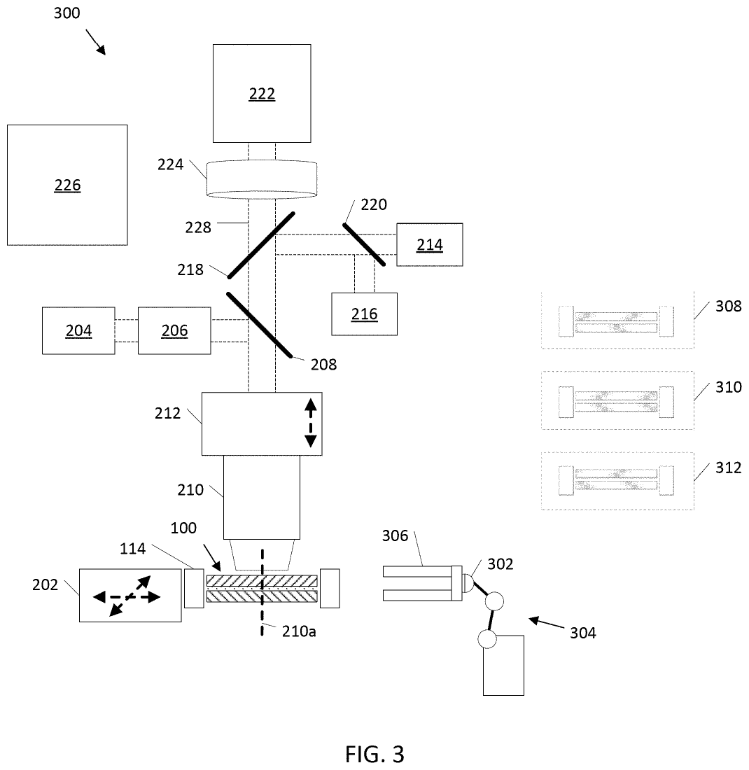

### FIG. 3 Imaging System

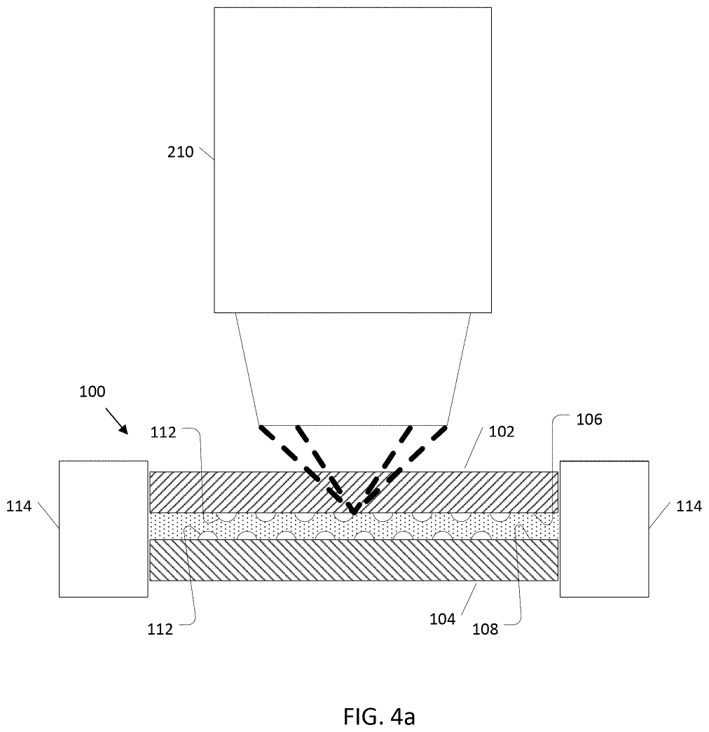

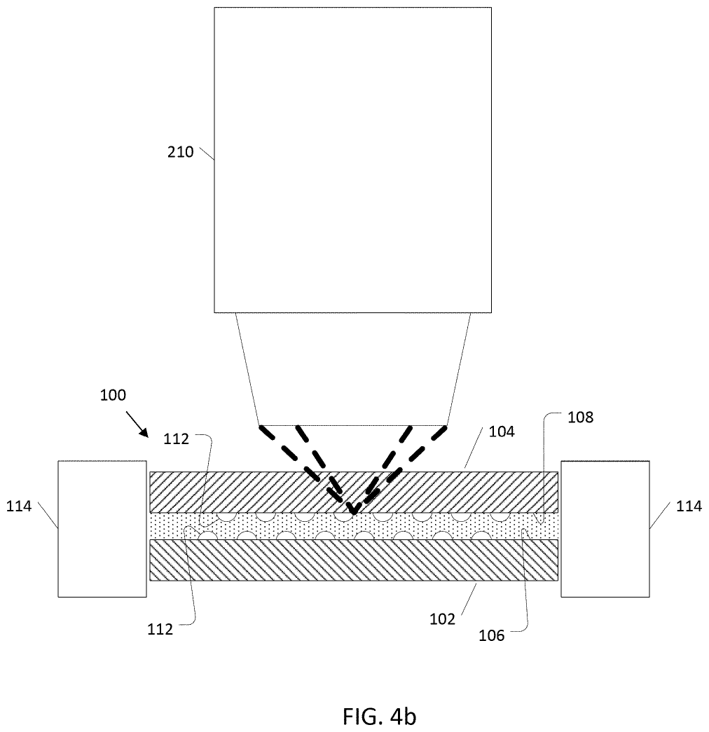

FIG. 3 shows another example of an imaging system 300. In this example, the system includes an actuator 302 that is configured change the orientation of flow cell 100 in the imaging system 300. For instance, the actuator 302 may be configured to flip the flow cell between an orientation in which the first substrate 102 is on top of the second substrate 104 (i.e. as shown in FIG. 4a) and an orientation in which the second substrate 104 is on top of the first substrate 102 (i.e. as shown in FIG. 4b).

When the flow cell is in the orientation shown in FIG. 4a, the system 300 is configured to image emitted radiation from tagged analyte on the first surface 106 of the flow cell 100. In the orientation shown in FIG. 4a, the objective 210 is focused on or proximate to the first surface 106 of the flow cell 100 (or on the analyte 112 associated with the first surface 106) such that the detector 222 captures focused images of stimulated emissions by tagged analyte on the first surface 106, but does not capture well focused images of stimulated emissions by tagged analyte on the second surface 108.

When the flow cell is in the orientation shown in FIG. 4b, the system 300 is configured to image emitted radiation from tagged analytes on the second surface 108 of the flow cell 100. In the orientation shown in FIG. 4b, the objective 210 is focused on or proximate the second surface 108 of the flow cell 100 such that the detector 222 captures images of stimulated emissions by the tagged analyte on the second surface 108, but does not capture images of stimulated emissions by the tagged analyte on the first surface 106.

Returning to FIG. 3, actuator 302 is configured to re-orient the flow cell between the orientation shown in FIG. 4a and the orientation shown in FIG. 4b, which is flipped 180 degrees from the orientation shown in FIG. 4a. In the example shown in FIG. 3, actuator 302 is a component of a flow cell transport device 304. Flow cell transport device 304 may be a robotic armature or other multi-degree of freedom device configured to re-position and re-orient flow cell 100. Flow cell transport device 304 includes a gripper 306 for gripping flow cell 100 (or for gripping a flow cell holder such as holder 114). Actuator 302 may be a rotary joint or other suitable mechanical linkage allowing flow cell transport device 304 to invert the orientation of gripper 306.

In addition to being able to flip over the flow cell 100, flow cell transport device 304 is also configured to move the flow cell 100 between various stations. In FIG. 3, flow cell 100 is positioned at an imaging station, and flow cell transport device 304 may move flow cell 100 to other stations such as stations 308, 310 where reagents may be flowed through flow cell 100 and other operations performed to facilitate sequencing reactions or other reactions with analyte, and station 312, where flow cell 100 may be temporarily held pending availability of another station.

### FIG. 3 Imaging System—Example Method of Operation

In one example method of operation of the imaging system 300 shown in FIG. 3, the flow cell transport device 304 may position flow cell 100 for imaging, with the flow cell 100 initially oriented as shown in FIG. 4a, with the first surface 106 closer to the objective 210 than the second surface 108. Next, based on feedback from the auto-focus sub-system, the system 300 focuses objective 210 for imaging emissions from fluorescently-tagged analyte 112 on the first surface 106 of flow cell 100, as shown in FIG. 4a. Next, radiation from radiation source 204 is scanned across the analyte 112 arrays of the flow cell 100 while detector 222 captures images of the stimulated emissions from tagged analyte 112 sites on the first surface 106 of the flow cell 100.

Next, the flow cell transport device 304 may re-orient the flow cell 100 into the orientation shown in FIG. 4b, with the second surface 108 closer to the objective 210 than the first surface 106. Next, based on feedback from the auto-focus sub-system, the system focuses objective 210 for imaging emissions from fluorescently-tagged analyte 112 on the second surface 108 of flow cell 100, as shown in FIG. 4b. Next, radiation from radiation source 204 is scanned across the analyte 112 arrays of the flow cell 100 while detector 222 captures images of the stimulated emissions from tagged analyte on the second surface 108 of the flow cell 100.

Next, the flow cell transport device 304 may reposition the flow cell 100 to another station, and position a new flow cell for imaging.

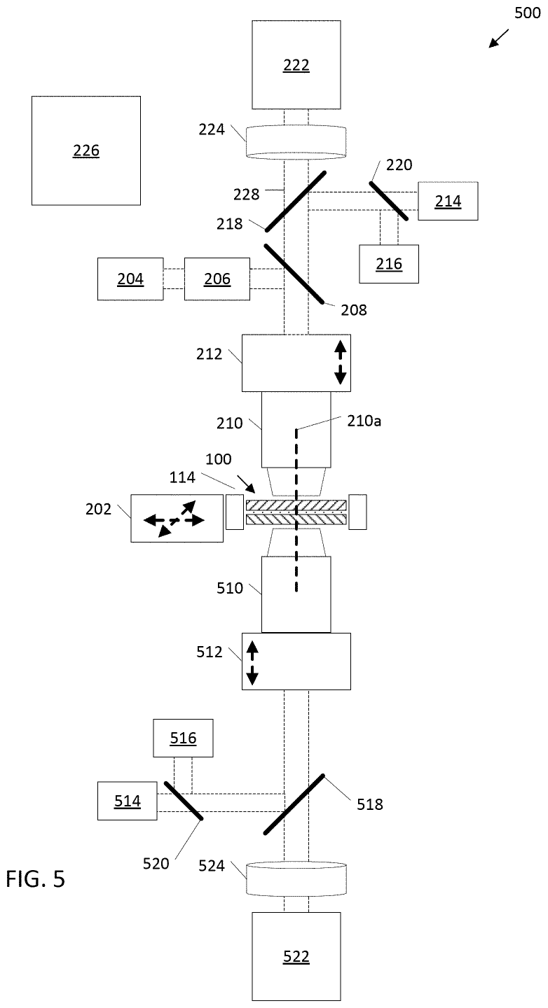

### FIG. 5 Imaging System

FIG. 5 shows another example of an imaging system 500. In this example, the imaging system 500 includes two imagers for simultaneously imaging emitted radiation at both surfaces 106, 108 of the flow cell 100. The imaging system 500 of FIG. 5 includes the same components as the imaging system 200 of FIG. 2, and also includes an additional objective 510, z-translation stage 512, detector 522, detector optics 524, and auto-focus components 514, 516, 518, 520.

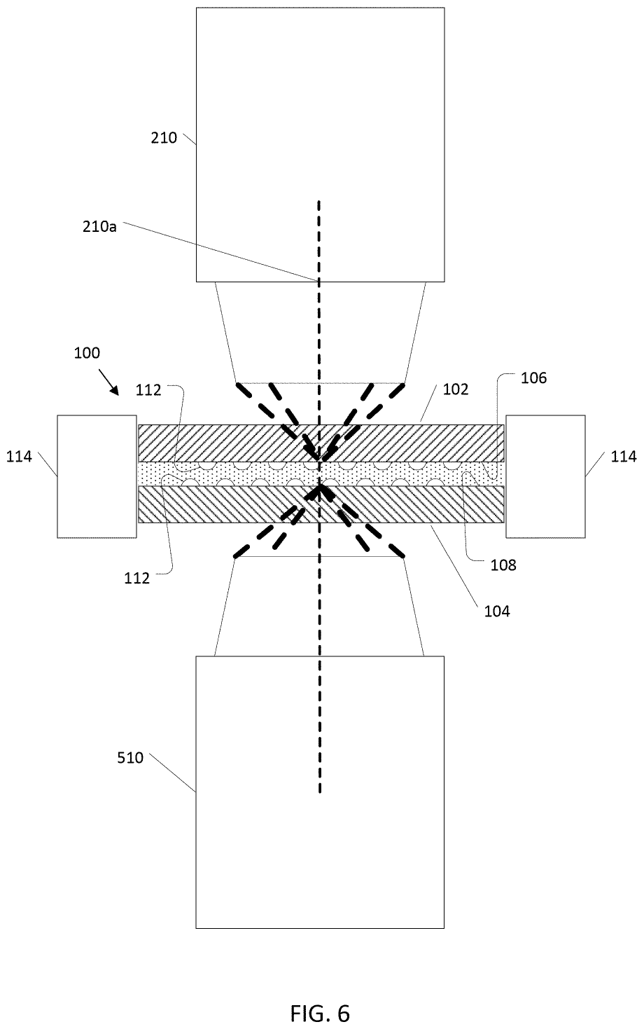

In this example, the auto-focus components 214, 216, 218, 220 facilitate focusing objective 210 on the inner surface of the double-sided flow cell 100 closest to objective 210—the first surface 106 of first substrate 102, and the auto-focus components 514, 516, 518, 520 facilitate focusing objective 510 on the inner surface of the double-sided flow cell 100 closest to objective 510—the second surface 108 of second substrate 104 (see FIG. 6). The system 500 may be configured such that the IR laser or other radiation generated by radiation source 214 for auto-focusing objective 210 does not interfere with the auto-focusing does of the other objective 510. For example, the geometry of each of the auto-focusing sub-systems could be configured such that the IR laser or other radiation used for auto-focusing objective 210 is not detected by or otherwise does not interfere with the detector 516 of the other auto-focus subsystem and vice-versa. Alternatively, the auto-focusing sub-system used for objective 210 may be configured to operate on different wavelengths than the auto-focusing sub-system used for objective 510.

By focusing each objective of the surface of the flow cell closest to that objective, the imaging system 500 does not need to correct for any variation in the thickness of the water gap of the double-sided flow cell 100.

As shown in FIGS. 5 and 6, the flow cell 100 is positioned between the two objectives 210, 510, with objective 210 facing the first substrate 102 of the flow cell 100 and objective 510 facing the second substrate 104 of the flow cell 100. As also shown in FIGS. 5 and 6, the optical axes 210a of the objectives 210, 510 are co-linear.

In the imaging system 500 of FIG. 5, radiation from radiation source 204 stimulates emissions from tagged analyte 112 on both surfaces 106, 108 of flow cell 100 simultaneously. In the particular example shown, a single laser beam is scanned across the flow cell along x and y axes using x/y stage 202 to simultaneously stimulate emissions from tagged analyte 112 on both surfaces 106, 108 at the location of the laser beam.

As the laser beam is scanned across the flow cell 100, the system 500 simultaneously images emitted radiation from tagged analyte on surface 106 and emitted radiation from tagged analyte on surface 108. The system 500 images emitted radiation from tagged analyte on surface 106 using objective 210, optics 224, and detector 222. The system 500 images emitted radiation from tagged analyte on surface 108 using objective 510, optics 524, and detector 522.

### FIG. 5 Imaging System—Example Method of Operation

In one example method of operation of the imaging system 500 shown in FIG. 5, flow cell 100 may be positioned for imaging between objectives 210, 510. Next, based on feedback from the auto-focus sub-systems, and as shown in FIG. 6, the system 500 focuses objective 210 for imaging emissions from fluorescently-tagged analyte on the first surface 106 of flow cell 100, and focuses objective 510 for imaging emissions from fluorescently-tagged analyte on the second surface 108. In this example, radiation source 214, detector 216, and directing optics 218, 220 are used in collecting data to position objective 210 for focused imaging of emissions from fluorescently-tagged analyte on the first surface 106 of the flow cell; and radiation source 514, detector 516, and directing optics 518, 520 are used in collecting data to position objective 510 for focused imaging of emissions from fluorescently-tagged analyte on the second surface 108 of the flow cell Next, radiation from radiation source 204 is scanned across the analyte 112 arrays of the flow cell 100 while detector 222 captures images of the stimulated emissions from tagged analyte on the first surface 106 of the flow cell 100 and detector 522 simultaneously captures images of the stimulated emissions from tagged analyte on the second surface 108 of the flow cell. As radiation source 204 is scanned, the auto-focusing sub-systems may adjust the focus of objectives 210, 510 to account for variations in the thickness of the water gap between first and second surfaces 106, 108.

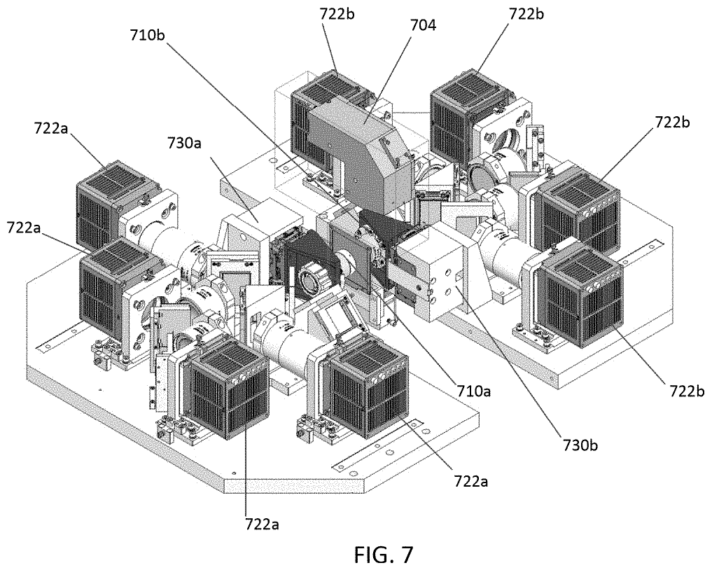

### FIG. 7 Imaging System

FIG. 7 shows another example of an imaging system 700 that includes two imaging sub-systems for simultaneously imaging emitted radiation at both surfaces of a flow cell. The imaging system 700 of FIG. 7 includes a single radiation source 704 for simultaneously stimulating emissions from tagged analyte on both surfaces of a flow cell (e.g. surfaces 106, 108 of the flow cell 100 shown in FIG. 1a). There are separate optical sub-systems for imaging each side of the flow cell. Objective 710a, detectors 722a, and auto-focus sub-system 730a are configured for imaging one of the surfaces of the flow cell (e.g. first surface 106 of flow cell 100 in FIG. 1a) and objective 710b, detectors 722b, and auto-focus sub-system 730b are configured for imaging the other surface (e.g. second surface 108 of flow cell 100 in FIG. 1a).

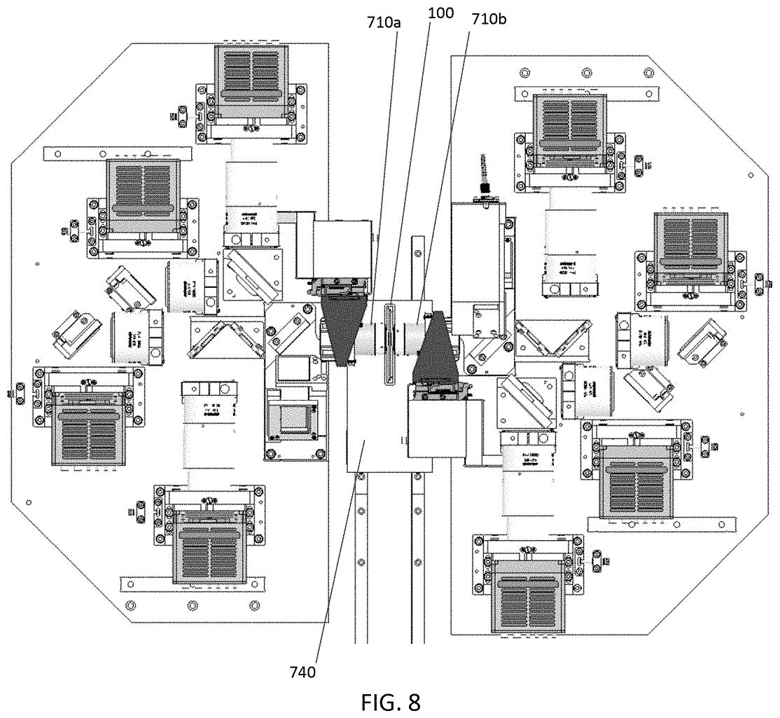

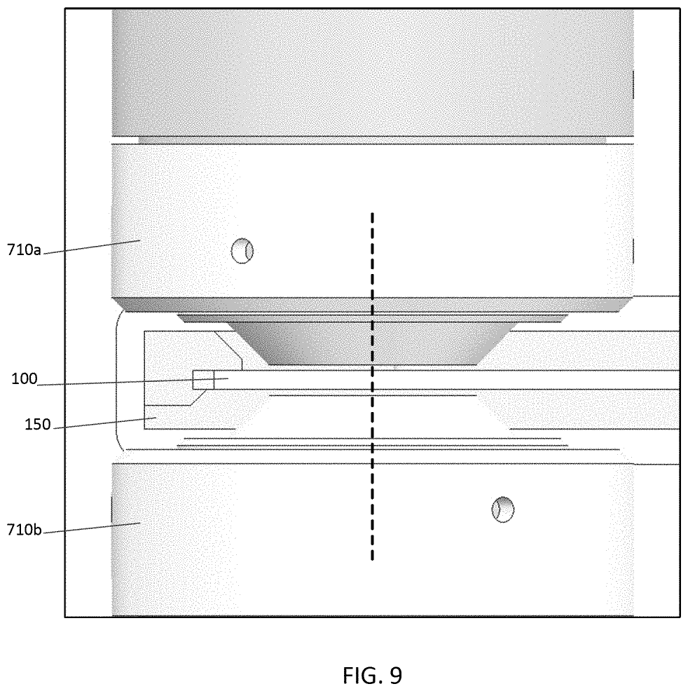

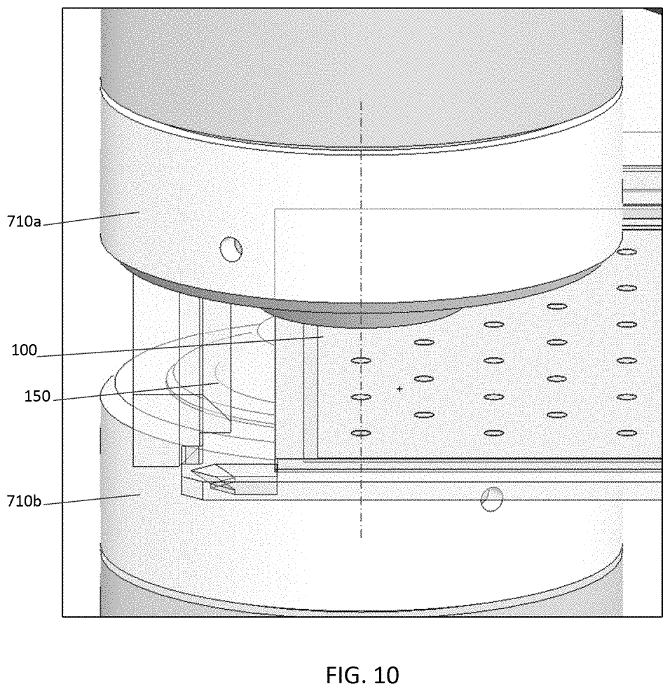

FIGS. 8-10 show additional views of the imaging system 700 of FIG. 7. FIG. 8 shows the imaging system 700 in plan view, along with a transport 740 for positioning flow cell 100 between the two objectives 710a, 710b. FIGS. 9 and 10 show a close up of the flow cell 100 in a holder 150 positioned between the two objectives 710a, 710b, with the optical axes of the two objectives in a co-linear arrangement.

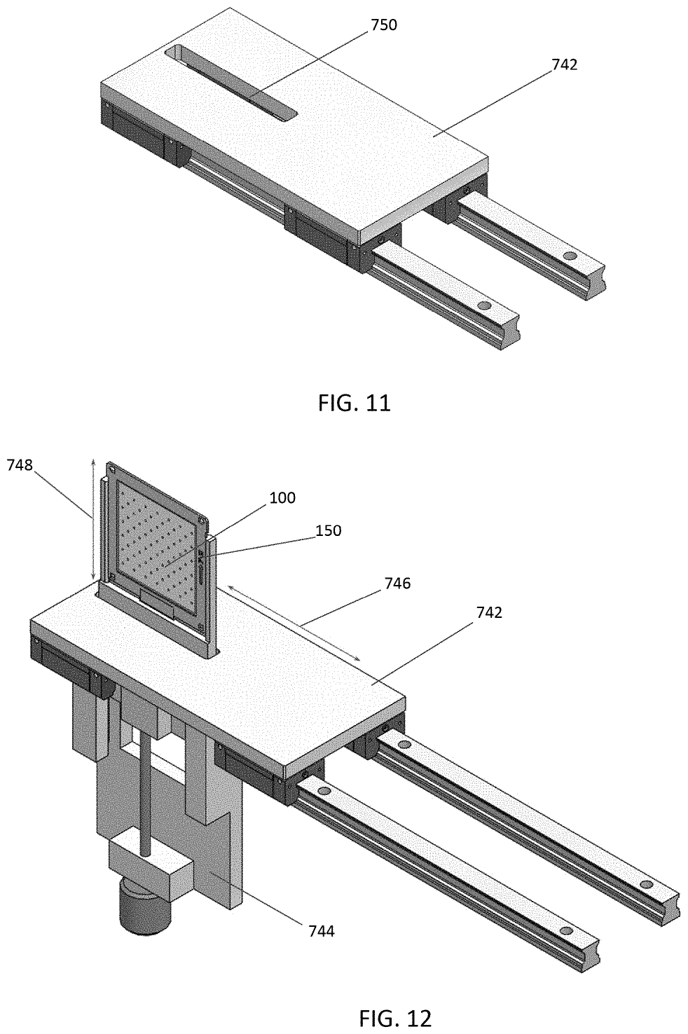

FIGS. 11 and 12 show additional views of the transport 740 of imaging system 700. FIG. 11 shows an x-stage 742 of the transport 740, and FIG. 12 shows both an x-stage 742 and a y-stage 744 of the transport 740. X-stage 742 is configured to translate flow cell 100 along an x-axis 746. Y-stage 744 is configured to translate flow cell 100 along a y-axis 748. Transport 740 may be configured for both gross movement (bringing the flow cell 100 to a location between the two objectives of the imaging system 700) and fine movement (translating the flow cell 100 along the x and y-axes 746, 748 to scan radiation across the flow cell 100).

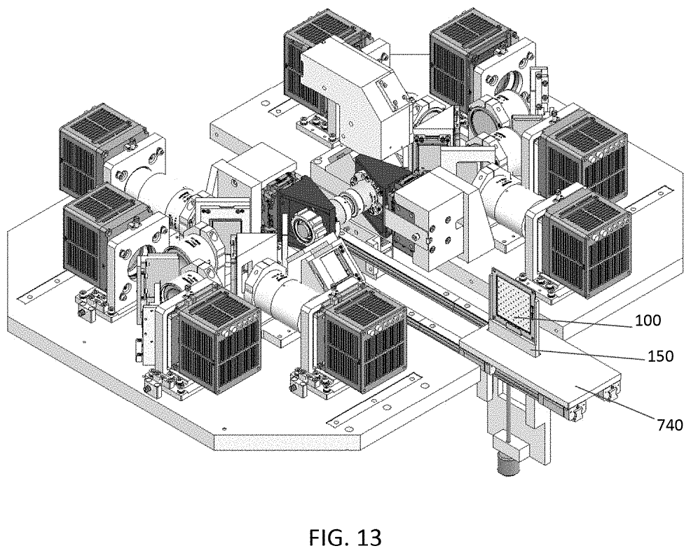

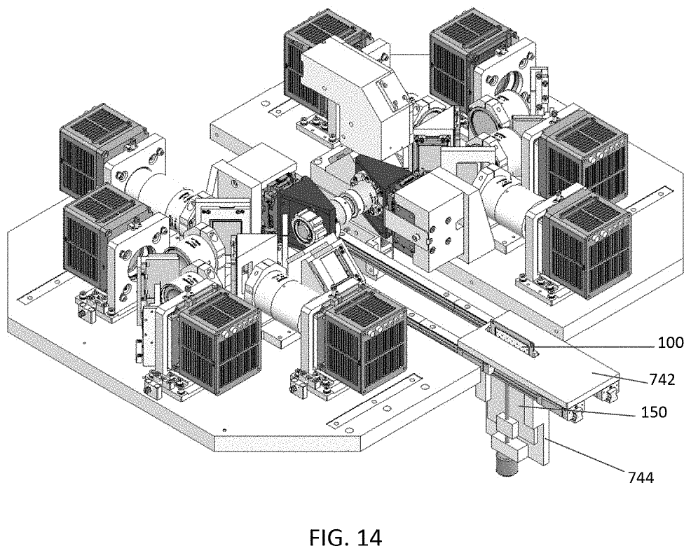

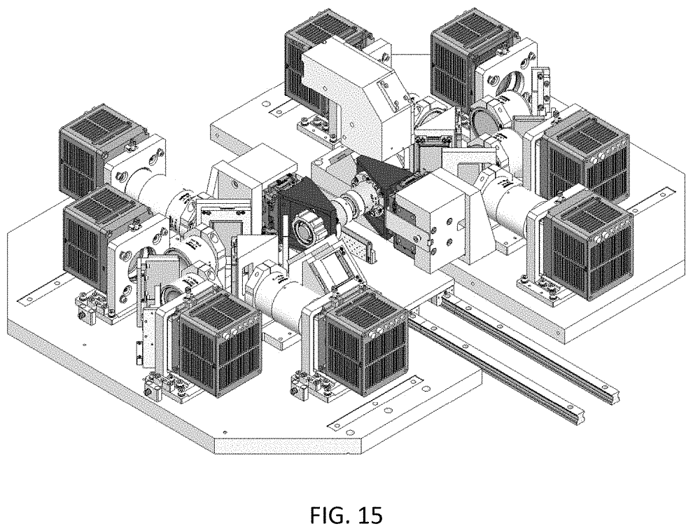

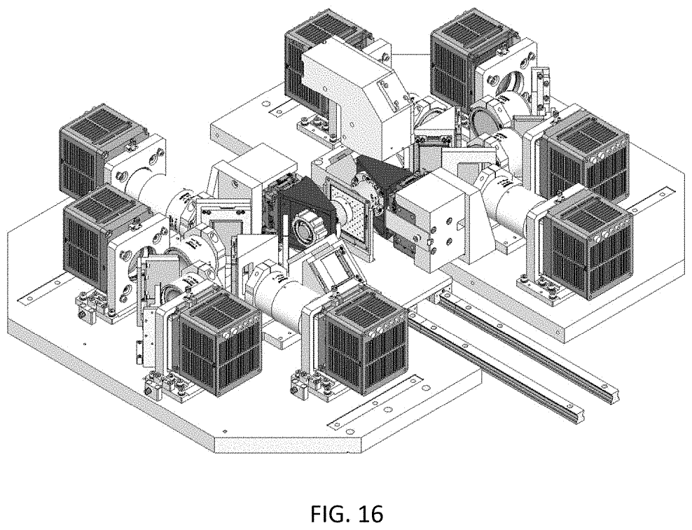

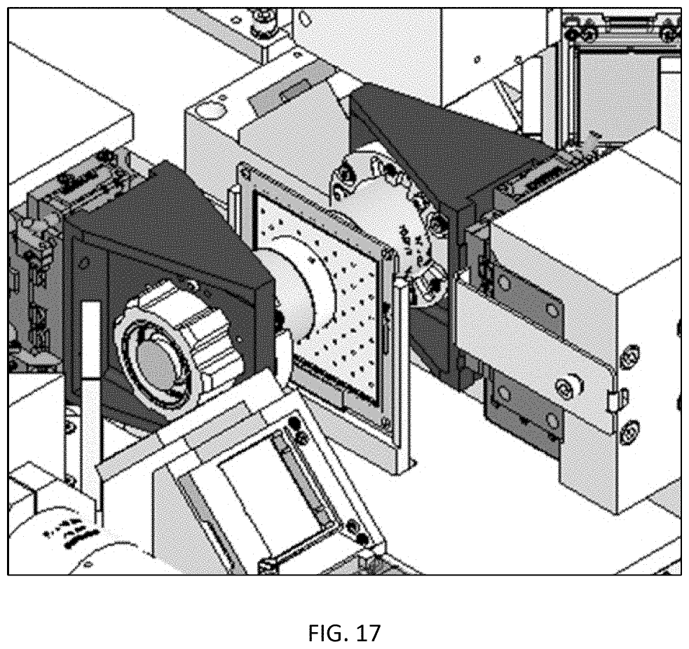

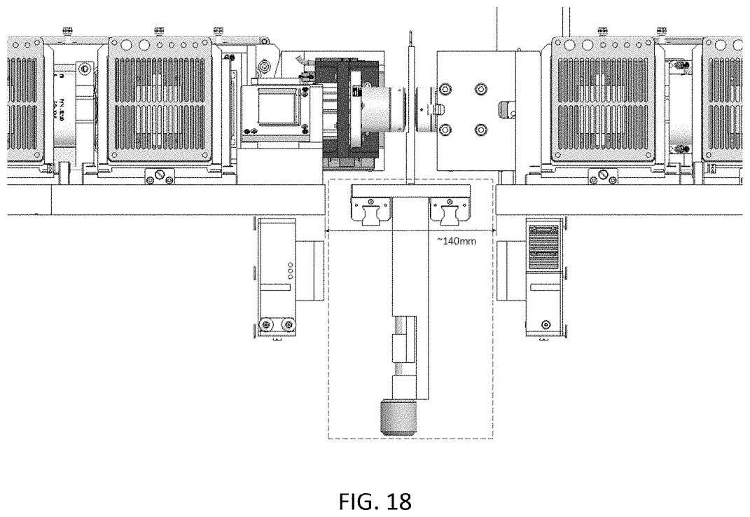

FIGS. 13-18 show use of the transport 740 to bring the flow cell 100 to a location between the two objectives of the imaging system 700. In FIG. 13, flow cell 100 is positioned in a holder 150 of the transport 740. In FIG. 14, y-stage 744 has been actuated to translate the flow cell 100 and holder 150 down through a slot 750 extending through the x-stage 742 (see FIG. 11). In FIG. 15, x-stage 742 has been actuated to translate the flow cell 100 and holder 150 to the objectives of the imaging system 700, and in FIGS. 16 and 17, y-stage has been actuated to translate the flow cell 100 and holder 150 back up through the slot 750 in x-stage 742, such that the flow cell 100 is positioned between the objectives of the imaging system 700.

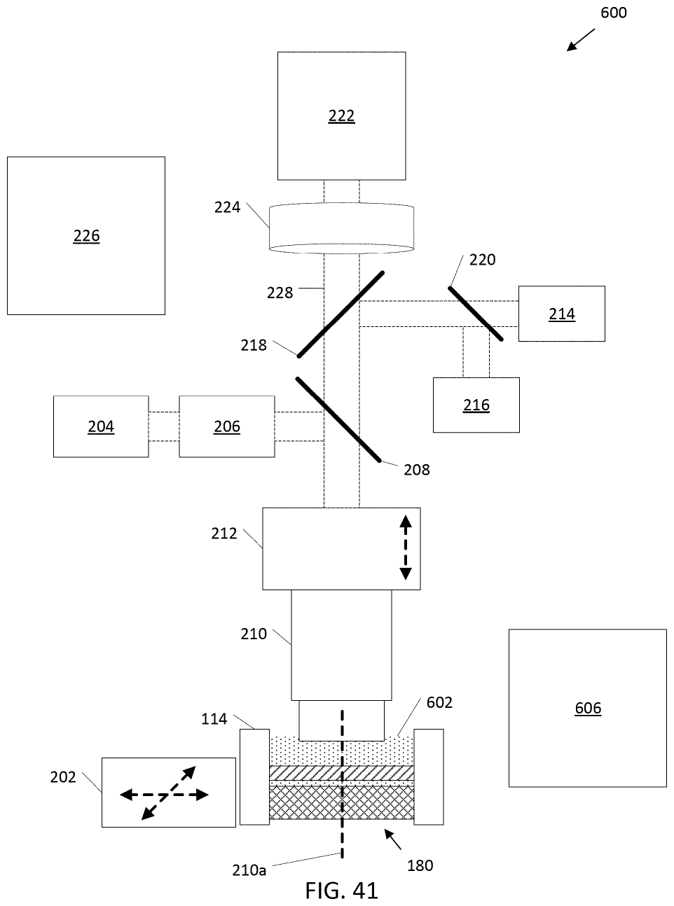

### FIG. 41 Imaging System

FIG. 41 shows another example of an imaging system 600. In this example, the objective 210 is an immersion objective, for example a water immersion objective. The imaging system 600 is configured so that emitted radiation at the first and second surfaces 106, 108 of the flow cell 180 can be imaged via objective 210 through equal or substantially equal thicknesses of fluid, despite the two surfaces 106, 108 being separated by a fluid passageway.

The distal end of the objective 210 is immersed in a fluid 602 (e.g. water) such that there is no air gap between the distal end of the objective 210 (or the distal lens in the objective 210) and the flow cell 180. The fluid may be retained in a reservoir covering the upper substrate of the flow cell 180. In the particular example shown, walls of the holder 114 retain the fluid 602 in a reservoir on top of the first substrate 102. In one non-limiting example, the depth of the reservoir may be 200-500 micrometers in depth, or approximately 350 micrometers. In other examples, the fluid may be retained in a volume over the flow cell 108 in other ways, and may be of different depths. The imaging system 600 includes a fluid monitoring and delivery sub-system 606 configured to maintain the fluid 602 at the desired level.

In some implementations, the fluid 602 above the flow cell 180 may have the same or substantially the same optical properties (e.g. index of refraction) as the fluid in the fluid passageway between the first and second substrates 102, 182 of the flow cell 180. In some implementations, the fluid 602 above the flow cell 180 may be the same or substantially the same as the fluid in the fluid passageway between the first and second substrates 102, 182 of the flow cell 180.

In this particular example, since the distal end of objective 210 will remain immersed in the fluid 602 during translation by the X-Y stage 202, undesirable turbulence could occur in the fluid 602, potentially affecting imaging quality. In some implementations, the objective 210 and other components of the system may be configured to reduce any turbulence in the fluid caused by the movement. For instance, in some configurations, the objective 210 may include a flat distal surface to facilitate a more laminar flow of the fluid relative to the objective and to decrease turbulence. In these or other configurations, the objective 210 (or at least portions of the objective 210 that are immersed in the fluid 602) may be un-tapered (e.g. cylindrical) to facilitate a more laminar flow of the fluid relative to the objective and to decrease turbulence.

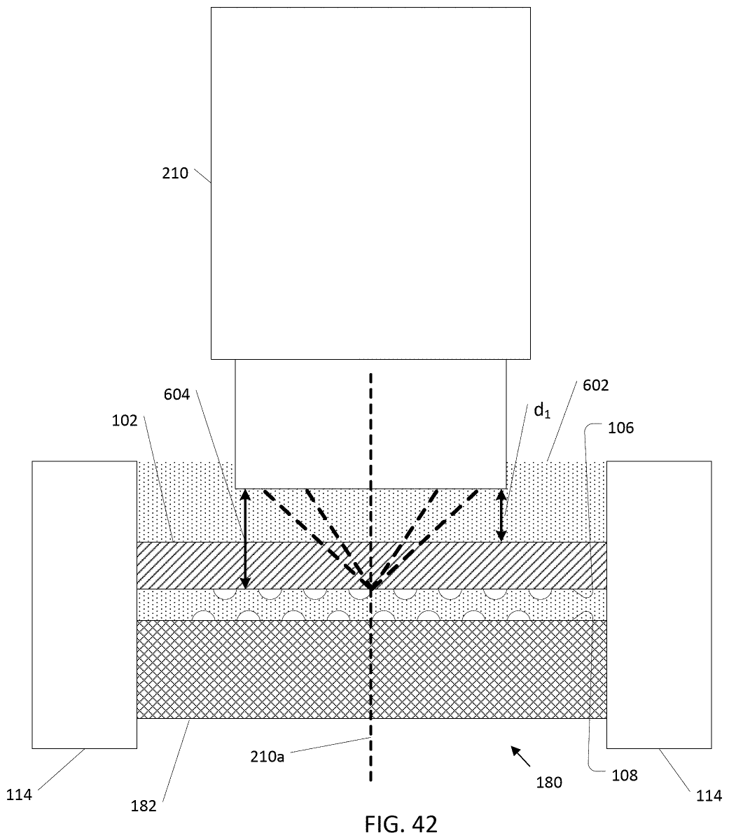

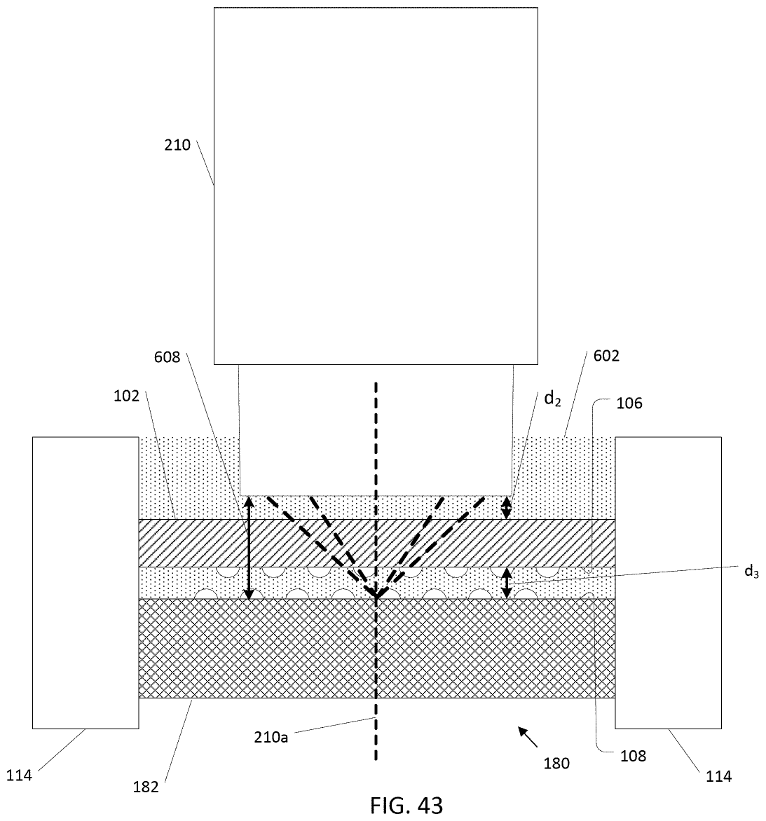

For the imaging system 600 of FIG. 41, the z-translation stage 212 is configured to translate the objective 210 along optical axis 210a to move the objective 210 from a location where the objective 210 is positioned to image emitted radiation from tagged analytes on the first surface 106 of the flow cell 180 to a location where the objective 210 is positioned to image emitted radiation from tagged analyte on the second surface 108 of the flow cell 180. FIG. 42 shows the objective 210 positioned to image emitted radiation from tagged analytes on the first surface 106 of the flow cell 180. FIG. 43 shows the objective 210 positioned to image emitted radiation from tagged analytes on the second surface 108 of the flow cell 180.

The imaging system 600 is configured so that the vertical distance 604 between the distal surface of the lens of the objective 210 and the first surface 106 when the objective 210 is positioned to image emitted radiation from tagged analytes on the first surface 106 (FIG. 42) is the same or substantially the same as the vertical distance 608 between the distal surface of the lens of the objective 210 and the second surface 108 when the objective 210 is positioned to image emitted radiation from tagged analytes on the second surface 108 (FIG. 43). Additionally, the vertical length of the optical path extending through fluid (including the fluid 602 in the region above the flow cell 180 and the fluid in the fluid passageway of the flow cell 180) and the vertical length of the optical path extending through flow cell substrate 102 is the same for the two objective positions shown in FIGS. 42 and 43. In FIG. 42, the vertical segment of the optical path traveling through fluid is labeled d₁. In FIG. 43, the vertical segments of the optical path traveling through fluid (including the fluid 602 above the flow cell 180 and the fluid in the flow cell 180 fluid passageway) are labeled d₂ and d₃ respectively.

The imaging system 600 is configured such that d₁ (when objective 210 is positioned to image emitted radiation at first surface 106) is equal to or approximately equal to d₂ plus d₃ (when objective 210 is positioned to image emitted radiation at second surface 108). When the objective 210 is re-positioned to image emitted radiation at second surface 108, the objective 210 is translated by z-translation stage 212 deeper into the fluid 602 by a distance equal to or approximately equal to d₃ (the height of the fluid passageway in the flow cell 180).

### Equivalent Optical Paths

The imaging system 600 of FIGS. 41-43 is configured such that the optical paths along optical axis of objective 210a between the distal end of the objective 210 and the surfaces of the flow cell 180 being imaged are equivalent or substantially equivalent regardless of whether emitted radiation at the first surface 106 or the second surface 108 is being imaged. The optical path extends vertically through the same thickness of fluid and substrate, regardless of whether the objective 210 is positioned to image emitted radiation at the first surface 106 (FIG. 42) or positioned to image emitted radiation at the second surface 108 (FIG. 43). In this way, an optical system including a high numerical aperture (NA) objective and otherwise specifically designed for particular imaging conditions may be used to image emitted radiation at two different surfaces of the flow cell 180 without introducing undesirable aberrations or otherwise negatively impacting on imaging quality. The systems 300, 500 of FIGS. 3 and 5 also have equivalent optical paths between the two surfaces being imaged. In those examples, the flow cell 100 is optically symmetric (both substrates 102, 104 are of the same or substantially the same material and thickness) and the optical path between the distal end of the objective(s) and the surface(s) being imaged are otherwise equivalent.

### FIG. 41 Imaging System—Example Method of Operation

In one example method of operation of the imaging system 600 shown in FIG. 41, flow cell 180 may be positioned for imaging, with fluid monitoring/delivery sub-system 606 ensuring fluid 602 sufficiently fills a reservoir above flow cell 180. Next, based on feedback from the auto-focus sub-system, the system 600 focuses objective 210 for imaging emissions from fluorescently-tagged analyte 112 on the first surface 106 of flow cell 180, as shown in FIG. 42. Next, radiation from radiation source 204 is scanned across the analyte 112 arrays of the flow cell 180 while detector 222 captures images of the stimulated emissions from tagged analyte 112 sites on the first surface 106 of the flow cell 180.

Next, z-translation stage 212 may vertically translate objective 210 downward by a distance equal to or substantially equal to a height of the fluid passageway of flow cell 180 (in one non-limiting example 50 microns). Next, based on feedback from the auto-focus sub-system, the system focuses objective 210 for imaging emissions from fluorescently-tagged analyte 112 on the second surface 108 of flow cell 180, as shown in FIG. 43. Next, radiation from radiation source 204 is scanned across the analyte 112 arrays of the flow cell 180 while detector 222 captures images of the stimulated emissions from tagged analyte on the second surface 108 of the flow cell 180.

### Other Double-Sided Substrates

FIG. 1a, discussed earlier, shows an example of a flow cell 100 including a first substrate 102 and a second substrate 104 positioned so that a first interior surface 106 of the first substrate 102 is spaced apart from and faces a second interior surface 108 of the second substrate 104, defining a fluid passageway 100 between those surfaces. Interior surfaces 106, 108 are configured to receive analyte 112 for analysis.

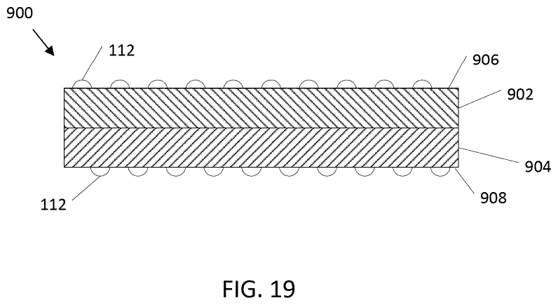

FIG. 19 shows another example of a double-sided substrate 900 in which the two surfaces configured to receive analyte 112 for analysis are exterior surfaces 906, 908, rather than interior surfaces. The double-sided substrate may be formed by first forming binding sites for analyte 112 on the surfaces 906, 908 of two individual substrates 902, 904 respectively, and subsequently adhering the two substrates 902, 904 together such that surfaces 906, 908 with formed binding sites for analyte 112 are on the exterior of the double-sided substrate.

These binding sites for analyte 112 may be fabricated by well-known lithography tools, such as 248-nm KrF (krypton fluoride), 193-nm ArF (argon-fluoride) lithography systems, or e-beam lithography systems. The arrays are typically separated with spaces between each other in ultra-high density, high density, medium density, or low density. At ultra-high density, separation is less than 250 nm. At high density, separation is 300 to 350 nm. At medium density, separation is 400 nm to 500 nm. At low density, separation is 500 nm or more. In some implementations (for example, some low density implementations) 2-dimensional patterning with photoresist is sufficient to sequester DNA nanoballs or other discrete nucleic acid samples. In some implementations (for example, some medium, high, or ultra-high density implementations), to reduce risk that discrete samples will not remain in single locations, smaller samples may be required, which may require 3-dimensional patterning for more efficient capturing of fluorescence from tagged DNA nanoballs or other tagged nucleic acid samples. In such implementations, 3-dimensional patterned well nanostructures can be developed by non-binding material as a well wall and binding material for the well bottom surface for sequestering DNA nanoballs.

Unlike the flow cell 100 in FIG. 1a, double-sided substrate 900 does not have a fluid passageway between the two substrates, and analyte 112 binding sites are on the exterior-facing surfaces 906, 908 of the substrates 902, 904. Sequencing or other reactions may be performed on the analyte 112 on double-sided substrate 900 by sequentially dipping or otherwise immersing double-sided substrate 900 into reagents and other fluids. In one example, during sequencing reactions, fluorescently-tagged molecules may selectively bind to some of the analyte 112 on surfaces 906, 908 of double-sided substrate 900. Sequencing reactions that are the same or similar to the immersion reaction protocols described in US 2020/00318177 A1, published Oct. 8, 2020 to Yang et al., may be performed on the double-sided substrate 900.

Double-sided substrate 900 may be imaged by the imaging systems described above. For example, for the imaging system 300 shown in FIG. 3, the flow cell transport device 304 may position double-sided substrate 900 for imaging, with the double-sided substrate 900 initially oriented with the first surface 906 closer to the objective 210 than the second surface 908. Next, based on feedback from the auto-focus sub-system, the system 300 focuses objective 210 for imaging emissions from fluorescently-tagged analyte 112 on the first surface 906 of double-sided substrate 900. Next, radiation from radiation source 204 is scanned across the analyte 112 arrays on the first surface 906 while detector 222 captures images of the stimulated emissions from tagged analyte 112 sites. Next, the flow cell transport device 304 may re-orient the double-sided substrate 900 with the second surface 908 closer to the objective 210 than the first surface 906. Next, based on feedback from the auto-focus sub-system, the system focuses objective 210 for imaging emissions from fluorescently-tagged analyte 112 on the second surface 908. Next, radiation from radiation source 204 is scanned across the analyte 112 arrays on the second surface 908 while detector 222 captures images of the stimulated emissions from tagged analyte on the second surface 908. Next, the transport device 304 may reposition the double-sided substrate 900 to another station, and position a new double-sided substrate 900 for imaging.

As another example, for the imaging system 500 of FIG. 5, double-sided substrate 900 may be positioned for imaging between objectives 210, 510. Next, based on feedback from the auto-focus sub-systems, the system 500 focuses objective 210 for imaging emissions from fluorescently-tagged analyte on the first surface 906 of the double-sided substrate 900, and focuses objective 510 for imaging emissions from fluorescently-tagged analyte on the second surface 908. In this example, radiation source 214, detector 216, and directing optics 218, 220 are used in collecting data to position objective 210 for focused imaging of emissions from fluorescently-tagged analyte on the first surface 906; and radiation source 514, detector 516, and directing optics 518, 520 are used in collecting data to position objective 510 for focused imaging of emissions from fluorescently-tagged analyte on the second surface 908. Next, radiation from radiation source 204 or radiation sources (e.g. from one radiation source configured for stimulating emissions of tagged analyte 112 on the first surface 906 and a second radiation source configured for stimulating emissions of tagged analyte 112 on the second surface 908) is scanned across the analyte 112 arrays while detector 222 captures images of the stimulated emissions from tagged analyte on the first surface 906 and detector 522 simultaneously captures images of the stimulated emissions from tagged analyte on the second surface 908 of the flow cell. As radiation source 204 is scanned, the auto-focusing sub-systems may adjust the focus of objectives 210, 510 to account for variations in first and second surfaces 906, 908.

### Auto-Focus System

An objective (e.g., objective 210 in FIG. 2) used to focus light from a flow cell to a detector often has a narrow depth of focus (e.g., on the order of ¼ μm). A thickness of a water gap of a flow cell can vary from flow cell to flow cell over an area of each flow cell, wherein the variation is greater than the depth of focus of the objective. In some embodiments, to obtain acceptable image quality of analytes on one or both surfaces of a double-sided flow cell, it is desirable to have a system that can focus on one or both surfaces of the double-sided flow cell, without being influenced by reflections from another surface.

In some configurations, a sample (e.g., an analyte) is illumined with a small-diameter, off-axis beam. Illuminating the sample with the small, off-axis beam is a geometry that can provide good sensitivity and/or allow separation of reflections from surfaces of the flow cell. An array detector can be used to track spots (e.g., spots of analytes and/or reflections). By appropriately defining blocks of pixels, desired spots can be isolated and used to control where the system thinks “focus” is located. Using a Sum and/or Diff algorithm allows fast and/or efficient generation of a Focus Error signal (e.g., this approach is numerically faster than measuring a spot centroid).

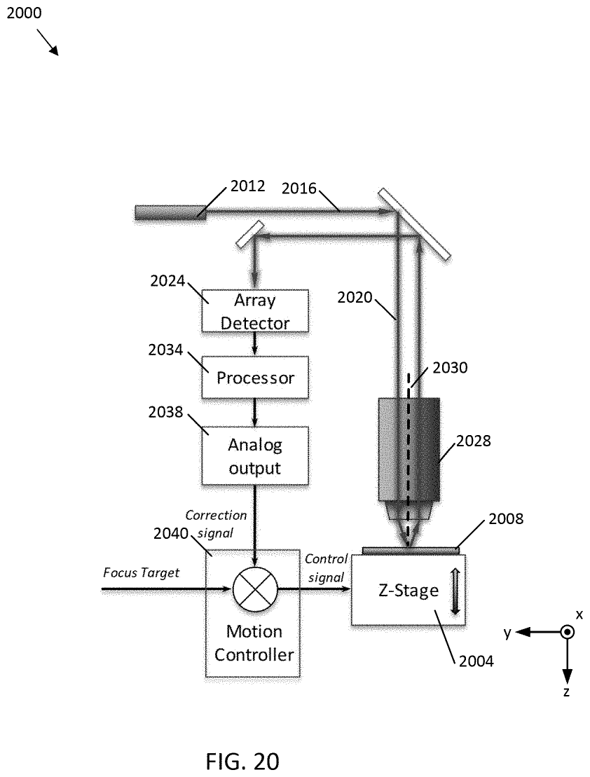

### FIG. 20—Auto-Focusing System

Referring to FIG. 20, an embodiment of a system 2000 for auto-focusing a flow cell is shown. The system 2000 comprises a stage 2004 configured to hold a carrier 2008 (e.g., a flow cell); a light source 2012 configured to emit an optical beam 2016 to illuminate an analyte on the carrier 2008, wherein the optical beam 2016 is characterized by an optical path 2020; a detector 2024; and a lens system 2028 characterized by an optical axis 2030.

The carrier 2008 is configured to be attached with the stage, while the analyte is illuminated by the optical beam 2016. The stage 2004 is configured to move the carrier 2008 in an X/Y plane. The stage 2004, in this embodiment, is also configured to move the carrier 2008 along the Z-axis (sometimes referred to as a Z-stage), wherein the Z-axis is defined as parallel to the optical axis 2030 of the lens system 2028. Controlling motion along the Z-axis modifies a distance between the lens system 2028 and the carrier 2008. In some embodiments, the stage 2004 moves the carrier 2008 in the X/Y plane (e.g., the X-Y stage 202 in FIG. 2), and another stage (e.g., the Z-translation stage 212 in FIG. 2) is used to control the distance between the lens system 2028 and the carrier 2008.

The light source 2012 is a laser (e.g., an infrared laser). The light source 2012 is configured to illuminate the analyte on the carrier 2008 by generating the optical beam 2016. The optical beam 2016 is configured to propagate through the lens system 2028 to illuminate the analyte on the carrier 2008.

The detector 2024 (e.g., an array detector) is configured to detect light. In some embodiments, the detector 2024 comprises a TDI (time delay and integration) sensor. The lens system 2028 is configured to focus light from the analyte onto the detector 2024, after the optical beam 2020 illuminates the analyte. A first block of pixels and a second block of pixels of the detector 2024 are defined. A first light intensity based on light detected by the first block of pixels of the detector 2024 is calculated. A second light intensity based on light detected by the second block of pixels of the detector 2024 is calculated. The first light intensity is compared to the second light intensity to generate a focus error signal. An analog output 2038 is generated based on the focus error signal and fed to a controller 2040. The controller 2040 is configured to change a distance between the carrier 2008 and the lens system 2028 by sending a control signal to the stage 2004 to move the carrier 2008 in the Z-direction. Moving the carrier 2008 in the Z-direction, or moving the lens system 2028 in the Z-direction, adjusts the focus of light on the detector 2024.

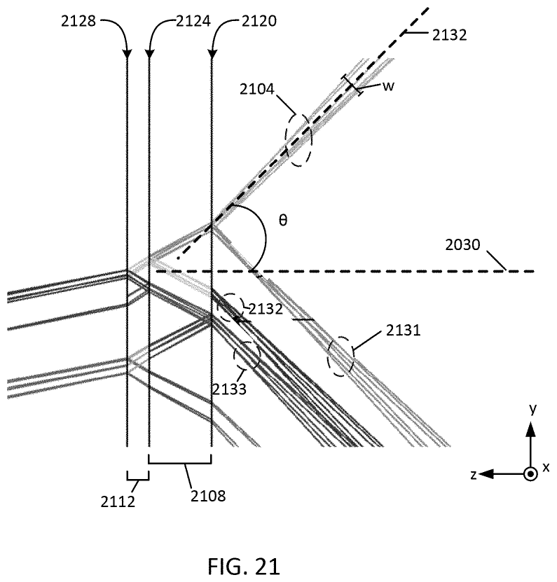

FIG. 21—Narrow-Beam Reflections from a Flow Cell

In some imaging systems, light from an optical source fills half a pupil of a lens system. In those systems, reflections from different surfaces are mixed at the detector. FIG. 21 depicts an embodiment of reflections from an illumination beam 2104, wherein reflections from surfaces can be differentiated. Instead of filling half the pupil, the illumination beam 2104 in FIG. 21 is narrow and provides off-axis illumination.

FIG. 21 shows a coverslip 2108 and a flow layer 2112. The coverslip 2108 comprises a top surface 2120 and a bottom surface 2124. The flow layer 2112 is between the bottom surface 2124 of the coverslip 2108 and a substrate 2128 (e.g., a silicon or glass substrate). Also shown in FIG. 21 is the optical axis 2030 of the lens system 2028 from FIG. 20. The incident beam 2104 propagates along an optical path 2132. The optical path 2132 is incident upon the top surface 2120 of the coverslip 2108 at an angle theta (θ) with respect to the optical axis 2030.

The incident beam 2104 has a beam width w. The beam width w is narrow compared to the pupil of the lens system (e.g., lens system 2028 in FIG. 20). In some embodiments, the beam width w (e.g., as measured on the first incident surface, such as the top surface 2120 in FIG. 21) is equal to or less than ⅓, ¼, or ⅙ the diameter of the entrance pupil.

The incident beam 2104 causes a first reflection 2131 off the top surface 2120, a second reflection 2132 off the bottom surface 2124, and third reflection 2133 off the substrate 2128. Since the incident beam 2104 has a narrow width w, spots formed by the first reflection 2131, the second reflection 2132, and the third reflection 2133 do not overlap and show up as separate and distinct spots on a detector (e.g., on the detector 2024 in FIG. 20).

The incident beam 2104 is injected into one side of an objective (e.g., lens system 2028 in FIG. 20). Reflected light falls on the detector, after passing through the lens system. Location and/or motion of spots on the detector give information about the focus position (e.g., in the z-direction) of different surfaces. Algorithms are used by one or more processors (e.g., processor 2034 in FIG. 20) to generate an analog output signal which is used as feedback for Z-stage motion control electronics.

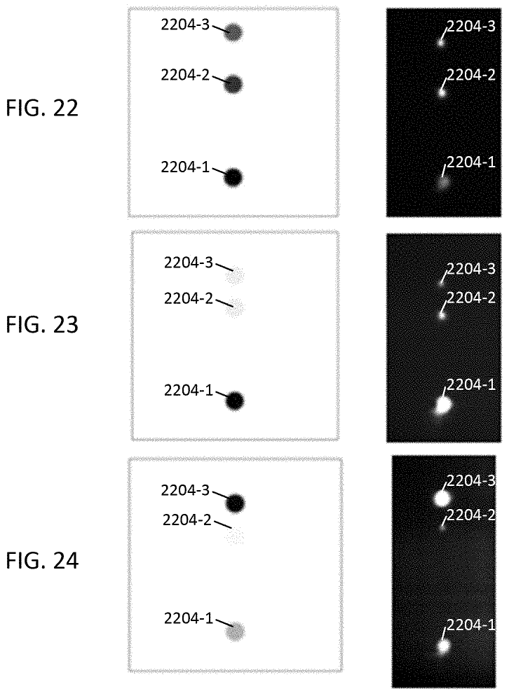

FIGS. 22-24—Focus Spots with Different Flow Cell Materials

FIGS. 22-24 illustrate embodiments of spots from reflections based on different flow cell materials. FIG. 22-24 show a simulation (ZEMAX) on the left and images on the right. A first spot 2204-1 (e.g., from the first reflection 2131 in FIG. 21) is from a reflection on a first surface (e.g., top surface 2120 FIG. 21); a second spot 2204-2 (e.g., from the second reflection 2132 in FIG. 21) is from a reflection on a second surface (e.g., bottom surface 2124 in FIG. 21); and a third spot 2204-3 (e.g., from the third reflection 2133 in FIG. 21) is from a reflection on a third surface (e.g., from substrate 2128 in FIG. 21).

In FIG. 22, there is an air gap between the second surface and the third surface, and the second surface and the third surface are glass. The three spots 2204 in FIG. 22 are about equal brightness. The second spot 2204-2 and the third spot 2204-3 are closer together than the second spot 2204-2 is to the first spot 2204-1 (e.g., because a thickness of the coverslip 2108 is greater than a thickness of the flow layer 2112 in FIG. 21).

In FIG. 23, there is water between the second surface and the third surface, and the second surface and the third surface are glass. The second spot 2204-2 and the third spot 2204-3 are lower intensity than the first spot 2204-1 because there is a smaller refractive index difference at those surfaces.

In FIG. 24, there is water between the second surface and the third surface, the second surface is glass, and the third surface is silicon. Reflection from the silicon surface is much brighter than from surfaces of the coverslip. The spacing between the first spot 2204-1 and the second spot 2204-2 is larger in FIG. 24 than in FIG. 23 because a thicker coverslip (250 μm thick) was used in FIG. 24 than in FIG. 23 (where a 170 μm coverslip was used.

The autofocus system is configured to adapt to various flow cell types, including the ones listed above in FIGS. 22 through 24.

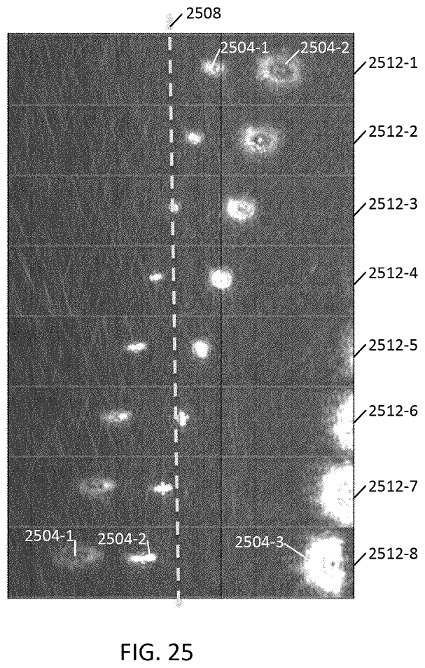

FIGS. 25-29—Focus Using Groups of Pixels

FIG. 25 is a montage of images from an embodiment of focusing on two reflection spots 2504. FIG. 25 shows a first spot 2504-1 and a second spot 2504-2 moving right to left past a focus position 2508, as the Z-stage moves the carrier in the Z-direction. The montage includes eight slides 2512, numbered one through eight. The slides 2512 are from a focus sweep on a glass-glass flow cell with 10-μm Z-steps.

The first spot 2504-1 is of the substrate, and the second spot 2504-2 is of the bottom surface of the coverslip. A third spot 2504-3, as seen in slides 2512-6, 2512-7, and 2512-8, is from the top surface of the coverslip.

As the Z-stage moves up and/or down, the spots 2504 shift on the detector (e.g., because the illumination beam is off axis). Focus error can be measured based on the shift of a spot 2504 on the detector. Because the spots 2504 are independent, the focus can be set to either surface of a flow cell without interference from the other. For example, the first spot 2504-1, of the substrate, is in focus in the third slide 2512-3; and the second spot 2504-2, of the bottom surface of the coverslip, is in focus in the sixth slide 2512-6.

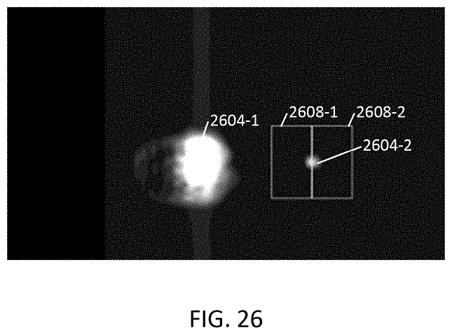

FIG. 26 is an embodiment of groups of pixels used for an auto-focus algorithm. FIG. 26 depicts a first spot 2604-1 and a second spot 2604-2 from a detector array. The first spot 2604-1 is from a reflection from a silicon substrate. The second spot 2604-2 is from a bottom surface of a coverslip. A first cell 2608-1 of a first group of pixels is next to a second cell 2608-2 of a second group of pixels. A first signal is generated by a total signal of light detected by pixels in the first cell 2608-1. A second signal is generated by a total signal of light detected by pixels in the second cell 2608-2. The first signal is compared to the second signal to generate an error signal.

The first signal plus the second signal is called SUM. The SUM provides information whether or not there is enough light on the detector to measure focus (e.g., if the SUM is equal to or above a predetermined threshold, then there is enough total light to run the focus algorithm). The first signal minus the second signal is called DIFF. The DIFF provides a measure of a position of the spot 2604 in the cells 2608. Applicant has experienced that it can be helpful to generate an auto-focus signal by normalizing the DIFF with the SUM, such that: AF signal=DIFF/SUM.

The spot 2604 approaches focus as the AF signal approaches zero (i.e., the spot 2604 is on a boundary between the first cell 2608-1 and the second cell 2608-2). If the focus of the sample needs shifted, the cells 2608 can simply be shifted (e.g., left or right) as defined on the sensor. A width of a cell 2608 is designed to be wide enough to find a spot 2604 when slightly out of focus, but not so wide as to pick up light from a spot 2604 of another surface. In some embodiments, a width of a cell 2608 is equal to or less than half the distance between centers of spots 2604. Though the sensor shown is a two-dimensional sensor, in some embodiments, a one-dimensional sensor is used (e.g., to provide a faster response), since horizontal distribution of light is what changes the DIFF.

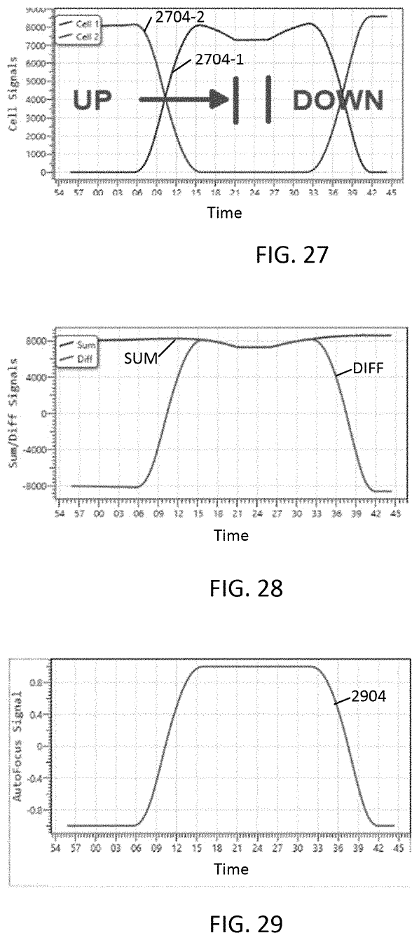

FIG. 27 depicts a graph of signals from cells while moving a spot across two pixel groups (e.g., cells 2608 in FIG. 26). FIG. 27 shows a first signal 2704-1 from a first cell (e.g., from light detected by the first cell 2608-1 in FIG. 26 as the second spot 2604-2 is moved from left to right) and a second signal 2704-2 from a second cell (e.g., from light detected by the second cell 2608-2 in FIG. 26) as the Z-stage moves up and then down through the focus, and the spot moves from one cell to another.

FIG. 28 depicts a graph of an embodiment of summation and difference of light from groups of pixels as focus is changed. In FIG. 28, plots of the SUM and DIFF of the cells are shown. Of note, the DIFF signal has both positive and negative values.

FIG. 29 depicts a graph of an embodiment of the autofocus (AF) Signal 2904. The AF signal 2904 is calculated by dividing the DIFF by the SUM. The AF signal 2904 is a unitless number between −1 and +1. The AF signal 2904 provides a magnitude and a direction of the Focus Error. A spot is in focus when the AF signal 2904 is equal to zero (e.g., when the spot is evenly between both cells 2608 in FIG. 26).

The AF signal and/or the SUM are output to the Z-stage controller. For example, a BrainBox (e.g., model ED-560) computer controlled output, or custom electronics that can include analog signal drivers, could be used.

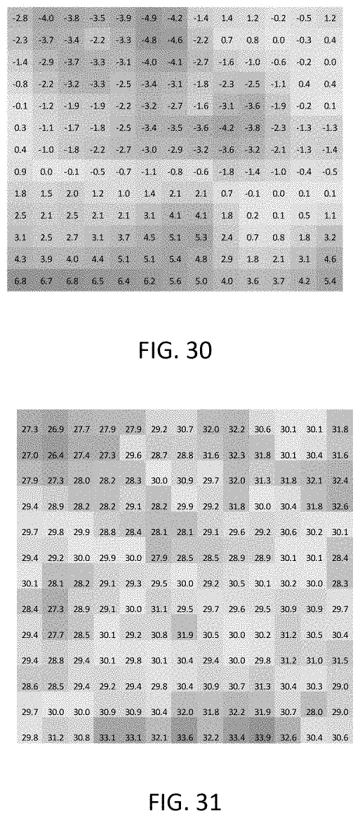

FIGS. 30-31—Heat Maps of Surfaces

The auto-focus system can be used to measure a water gap in a flow cell. The heat maps in FIGS. 30 and 31 cover a 60×60 mm area on a T7 flow cell.

FIG. 30 depicts a heat map of surface height of an embodiment of a flow cell.

FIG. 30 shows the height of a silicon surface of the flow cell. Height varies from +7 to −5 μm above an average.

FIG. 31 depicts a heat map of a thickness of an embodiment of a flow cell. A similar scan is run on a surface of the coverslip of the flow cell. Z-positions of the silicon surface are subtracted from Z-positions of the coverslip to measure the water gap. FIG. 31 shows the differences: ΔZ is about equal to 29±4 μm. Correcting for refraction makes the actual gap measurement, ΔZ, ^{˜}50±6 μm. This result is consistent with flow cell quality-control data. The gap variation is large compared to the depth of focus of the objective (e.g., lens system 2028 in FIG. 20).

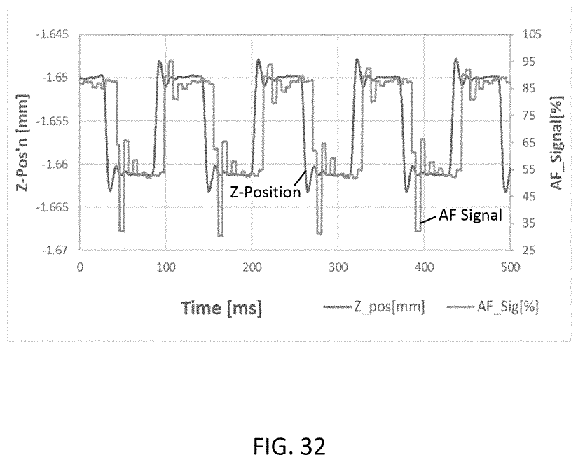

FIGS. 32-34—Lag in Sensing

FIG. 32 depicts a chart of lag time of an embodiment of a detector as the Z-stage is moved. It was expected there would be a lag from an implementation using a TDI camera and frame grabber. To measure the lag, the Z-stage was driven up and down (changing the Z-position) and the auto-focus (AF) signal was recorded. Data acquired shows the AF signal lags the actual Z-stage motion by about 11 ms. Through some algorithm improvements, the lag has been reduced to about 2 ms. To reduce lag further, a one-dimensional senor array and/or custom electronics can be used.

An ability of the AF system to stay in focus while scanning depends on: (1) a flatness of the surface, and (2) a lag time of the detector. One way to measure tracking error is to scan forward and backward along the surface (e.g., in the Y-direction) and look at the Z-difference.

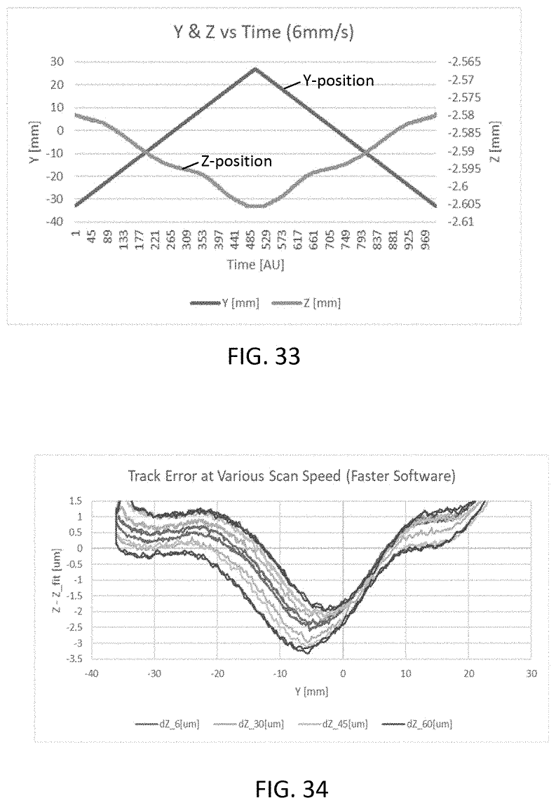

FIGS. 33 and 34 depict charts used to calculate autofocus error during scanning of an embodiment of a surface of a flow cell. In FIG. 33, Y-position verses time and Z-position verses time are shown, wherein auto focus is tracking the surface. FIG. 34 shows Z-position versus Y-position at different scan speeds. AF tracking error is a half of a vertical difference between two curves of the same color. For example, Blue (6 mm/s): Error <0.1 μm; Red (60 mm/s): Error <1 μm (which is too large for some embodiments).

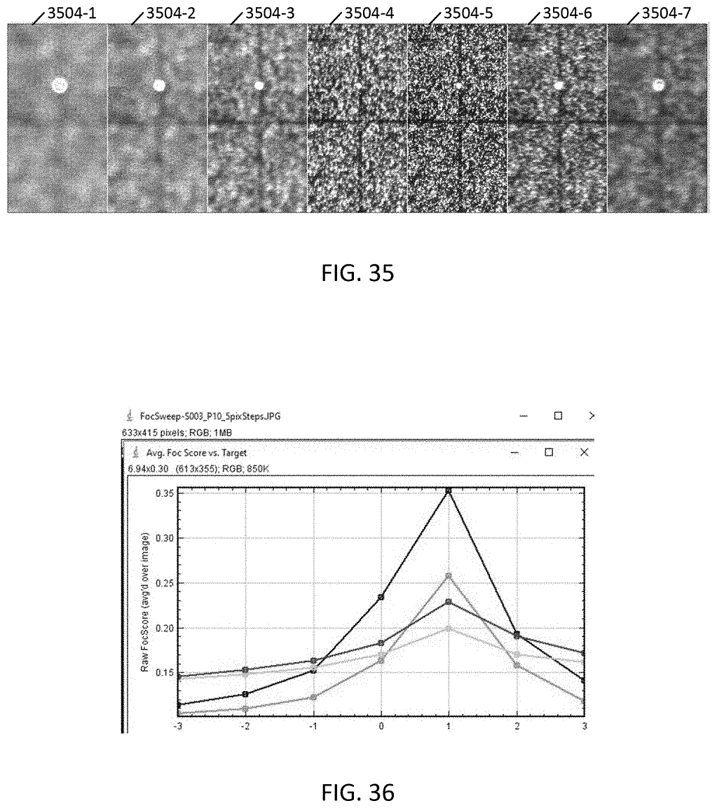

FIGS. 35-37—Focus Sweep

FIG. 35 depicts a series of images, or slides 3504, of a surface of an embodiment of a coverslip during a focus sweep. The focus sweep is a coarse focus sweep to find a setting for best focus. There are seven slides 3504 numbered one through seven. The images also show DNA nano-balls (DNBs).

FIG. 36 is a chart of an embodiment of a focus score plot during the focus sweep. The horizontal axis corresponds to a slide from FIG. 35. The first slide 3504-1 in FIG. 35 corresponds to “−3” on the chart, and the seventh slide 3504-7 in FIG. 35 corresponds to “3” on the chart. The position with value “1,” which corresponds to the fifth slide 3504-5 in FIG. 35, is the image in sharpest focus.

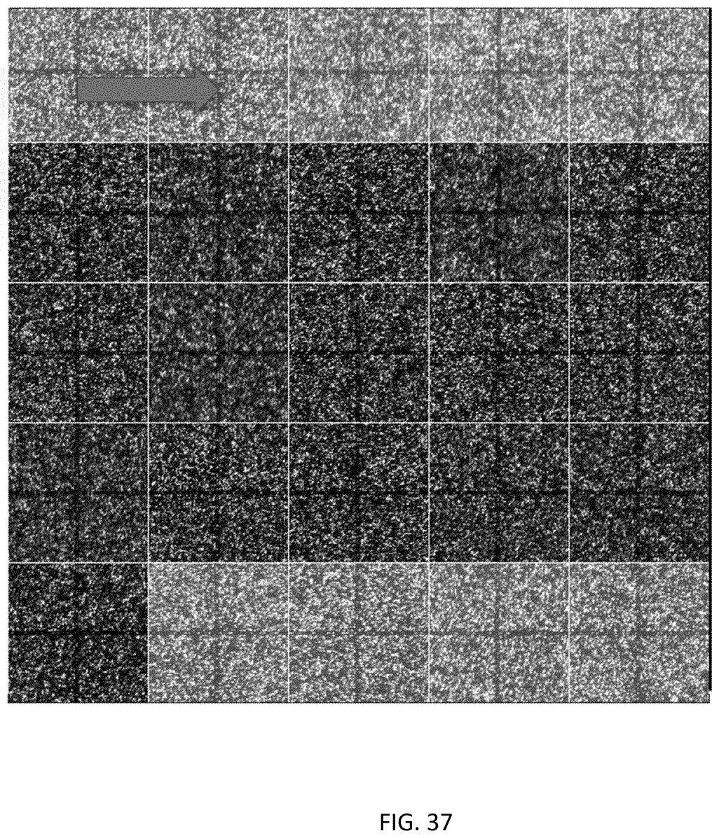

FIG. 37 depicts a series of images of a scan run on a patterned coverslip surface, scanned at 30 mm/s, wherein the coverslip has DNBs attached to the coverslip. Center images are darker due to bleaching from previous scans.

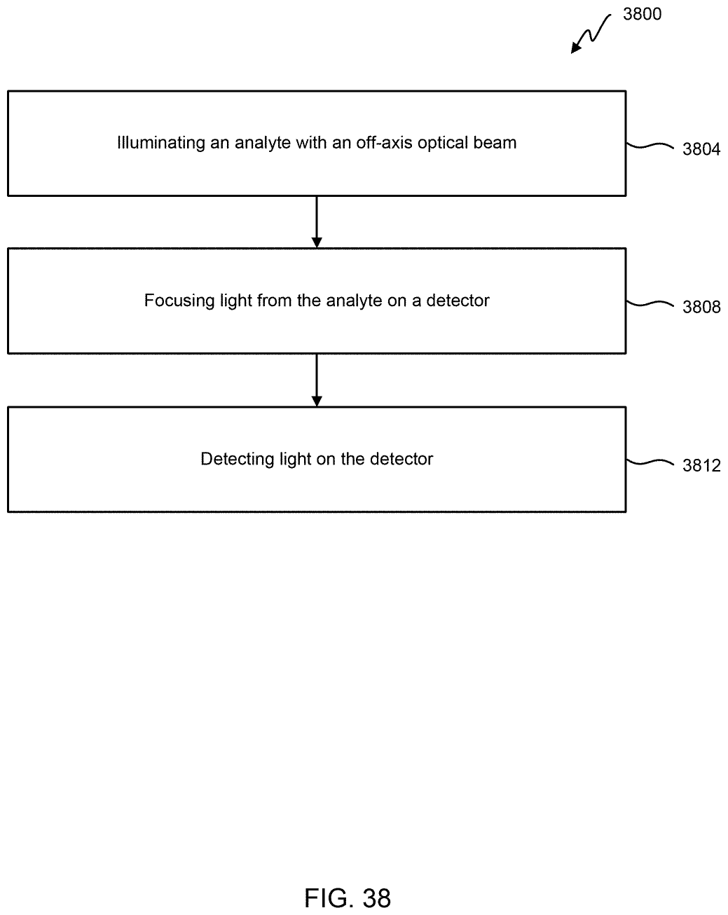

FIG. 38—Process for Imaging a Flow Cell

In FIG. 38, a flowchart of an embodiment of a process 3800 for imaging a flow cell is shown. Process 3800 begins in step 3804 with illuminating an analyte with a light source. The analyte is on a carrier, and the carrier is attached to a moveable stage. The analyte is illuminated by transmitting an optical beam of the light source through a lens system to the analyte. The optical beam is characterized by an optical path. The lens system is characterized by an optical axis. The optical path of the optical beam incident on the carrier is not parallel with the optical axis of the lens system (e.g., as shown in FIG. 21).

In step 3808, light from the analyte is focused on a detector, using the lens system. In step 3812, light from the analyte is detected by the detector.

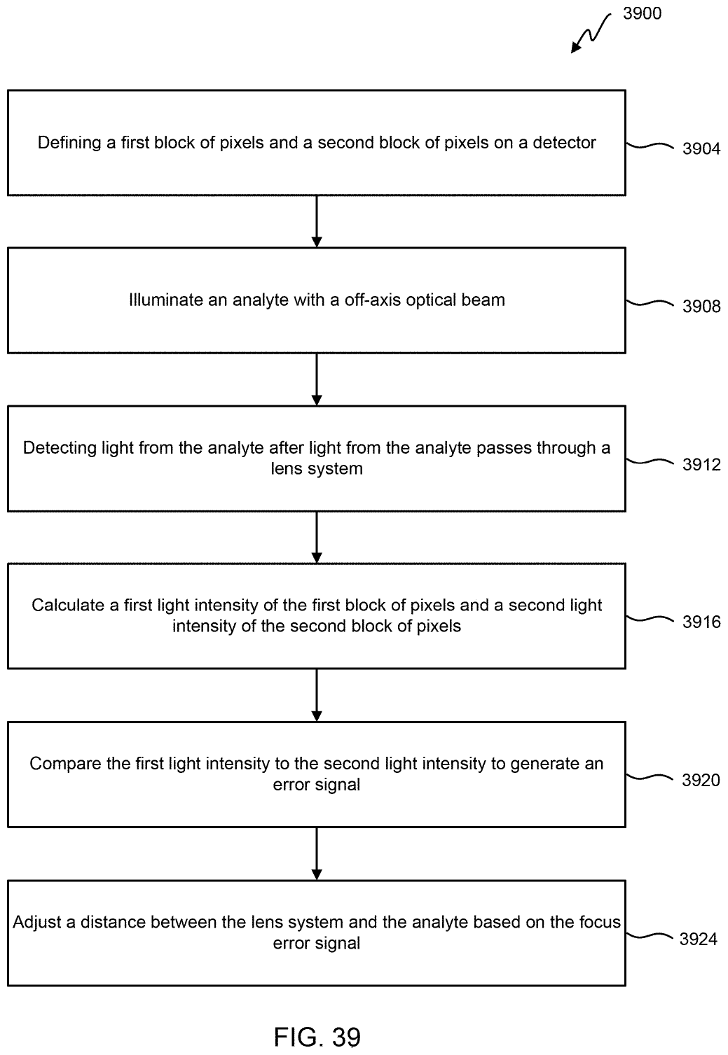

FIG. 39—Process for Auto Focus

In FIG. 39, a flowchart of an embodiment of a process 3900 for auto focus of a flow cell is shown. Process 3900 begins in step 3904 with defining a first block of pixels and a second block of pixels on a detector. For example, the first cell 2608-1 and the second cell 2608-2 in FIG. 26 are defined on a sensor of the detector 2024 in FIG. 20.

In step 3908, an analyte is illuminated with an off-axis optical beam. Light from the analyte is then detected by a detector, after light from the analyte passes through a lens system, step 3912.

In step 3916 a first light intensity is calculated and a second light intensity is calculated, wherein the first light intensity is calculated based on light detected by the first block of pixels of the detector, and the second light intensity is calculated based on light detected by the second block of pixels of the detector. The first light intensity is then compared to the second light intensity (e.g., calculating the SUM and DIFF as described with FIGS. 26-29) to generate a focus error signal (e.g., to generate the correction signal in FIG. 20, which is used to generate the control signal in FIG. 20; in some embodiments, the analog output 2038 in FIG. 20 comprises the AF signal from FIG. 32), step 3920.

In step 3924, a distance between the lens system and the analyte is adjusted, based on the focus error signal. For example, the Z-stage in FIG. 20 is moved closer and/or father away, in the z-direction, in relation to the lens system 2028.

In some embodiments, the analyte is a first analyte, and the method further comprises focusing on a second analyte that is on a second surface of the carrier. For example, the first analyte is on the bottom surface of a coverslip and the second analyte is on a substrate (e.g., a glass or silicon substrate), or on a surface of a second coverslip, of a flow cell.

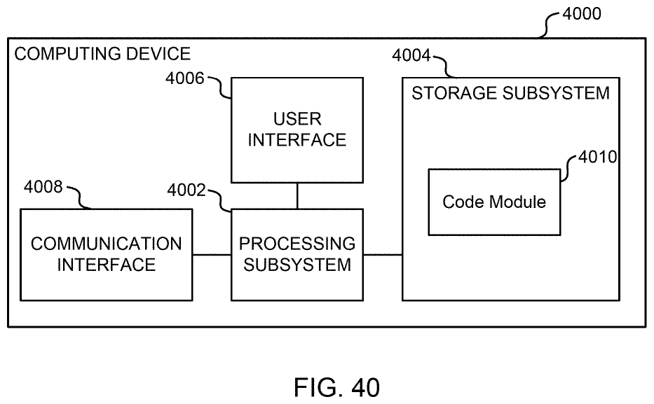

FIG. 40—Computing Device

FIG. 40 is a simplified block diagram of a computing device 4000. Computing device 4000 can implement some or all functions, behaviors, and/or capabilities described above that would use electronic storage or processing, as well as other functions, behaviors, or capabilities not expressly described. Computing device 4000 includes a processing subsystem 4002, a storage subsystem 4004, a user interface 4006, and/or a communication interface 4008. Computing device 4000 can also include other components (not explicitly shown) such as a battery, power controllers, and other components operable to provide various enhanced capabilities. In various embodiments, computing device 4000 can be implemented in a desktop or laptop computer, mobile device (e.g., tablet computer, smart phone, mobile phone), wearable device, media device, application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, or electronic units designed to perform a function or combination of functions described above.

Storage subsystem 4004 can be implemented using a local storage and/or removable storage medium, e.g., using disk, flash memory (e.g., secure digital card, universal serial bus flash drive), or any other non-transitory storage medium, or a combination of media, and can include volatile and/or non-volatile storage media. Local storage can include random access memory (RAM), including dynamic RAM (DRAM), static RAM (SRAM), or battery backed up RAM. In some embodiments, storage subsystem 4004 can store one or more applications and/or operating system programs to be executed by processing subsystem 4002, including programs to implement some or all operations described above that would be performed using a computer. For example, storage subsystem 4004 can store one or more code modules 4010 for implementing one or more method steps described above.

A firmware and/or software implementation may be implemented with modules (e.g., procedures, functions, and so on). A machine-readable medium tangibly embodying instructions may be used in implementing methodologies described herein. Code modules 4010 (e.g., instructions stored in memory) may be implemented within a processor or external to the processor. As used herein, the term “memory” refers to a type of long term, short term, volatile, nonvolatile, or other storage medium and is not to be limited to any particular type of memory or number of memories or type of media upon which memory is stored.

Moreover, the term “storage medium” or “storage device” may represent one or more memories for storing data, including read only memory (ROM), RAM, magnetic RAM, core memory, magnetic disk storage mediums, optical storage mediums, flash memory devices and/or other machine readable mediums for storing information. The term “machine-readable medium” includes, but is not limited to, portable or fixed storage devices, optical storage devices, wireless channels, and/or various other storage mediums capable of storing instruction(s) and/or data.

Furthermore, embodiments may be implemented by hardware, software, scripting languages, firmware, middleware, microcode, hardware description languages, and/or any combination thereof. When implemented in software, firmware, middleware, scripting language, and/or microcode, program code or code segments to perform tasks may be stored in a machine readable medium such as a storage medium. A code segment (e.g., code module 4010) or machine-executable instruction may represent a procedure, a function, a subprogram, a program, a routine, a subroutine, a module, a software package, a script, a class, or a combination of instructions, data structures, and/or program statements. A code segment may be coupled to another code segment or a hardware circuit by passing and/or receiving information, data, arguments, parameters, and/or memory contents. Information, arguments, parameters, data, etc., may be passed, forwarded, or transmitted by suitable means including memory sharing, message passing, token passing, network transmission, etc.

Implementation of the techniques, blocks, steps and means described above may be done in various ways. For example, these techniques, blocks, steps and means may be implemented in hardware, software, or a combination thereof. For a hardware implementation, the processing units may be implemented within one or more ASICs, DSPs, DSPDs, PLDs, FPGAs, processors, controllers, micro-controllers, microprocessors, other electronic units designed to perform the functions described above, and/or a combination thereof.

Each code module 4010 may comprise sets of instructions (codes) embodied on a computer-readable medium that directs a processor of a computing device 4000 to perform corresponding actions. The instructions may be configured to run in sequential order, in parallel (such as under different processing threads), or in a combination thereof. After loading a code module 4010 on a general purpose computer system, the general purpose computer is transformed into a special purpose computer system.

Computer programs incorporating various features described herein (e.g., in one or more code modules 4010) may be encoded and stored on various computer readable storage media. Computer readable media encoded with the program code may be packaged with a compatible electronic device, or the program code may be provided separately from electronic devices (e.g., via Internet download or as a separately packaged computer readable storage medium). Storage subsystem 4004 can also store information useful for establishing network connections using the communication interface 4008.

User interface 4006 can include input devices (e.g., touch pad, touch screen, scroll wheel, click wheel, dial, button, switch, keypad, microphone, etc.), as well as output devices (e.g., video screen, indicator lights, speakers, headphone jacks, virtual- or augmented-reality display, etc.), together with supporting electronics (e.g., digital to analog or analog to digital converters, signal processors, etc.). A user can operate input devices of user interface 4006 to invoke the functionality of computing device 4000 and can view and/or hear output from computing device 4000 via output devices of user interface 4006. For some embodiments, the user interface 4006 might not be present (e.g., for a process using an ASIC).

Processing subsystem 4002 can be implemented as one or more processors (e.g., integrated circuits, one or more single core or multi core microprocessors, microcontrollers, central processing unit, graphics processing unit, etc.). In operation, processing subsystem 4002 can control the operation of computing device 4000. In some embodiments, processing subsystem 4002 can execute a variety of programs in response to program code and can maintain multiple concurrently executing programs or processes. At a given time, some or all of a program code to be executed can reside in processing subsystem 4002 and/or in storage media, such as storage subsystem 4004. Through programming, processing subsystem 4002 can provide various functionality for computing device 4000. Processing subsystem 4002 can also execute other programs to control other functions of computing device 4000, including programs that may be stored in storage subsystem 4004.

Communication interface 4008 can provide voice and/or data communication capability for computing device 4000. In some embodiments, communication interface 4008 can include radio frequency (RF) transceiver components for accessing wireless data networks (e.g., Wi-Fi network; 3G, 4G/LTE; etc.), mobile communication technologies, components for short range wireless communication (e.g., using Bluetooth communication standards, NFC, etc.), other components, or combinations of technologies. In some embodiments, communication interface 4008 can provide wired connectivity (e.g., universal serial bus, Ethernet, universal asynchronous receiver/transmitter, etc.) in addition to, or in lieu of, a wireless interface. Communication interface 4008 can be implemented using a combination of hardware (e.g., driver circuits, antennas, modulators/demodulators, encoders/decoders, and other analog and/or digital signal processing circuits) and software components. In some embodiments, communication interface 4008 can support multiple communication channels concurrently. In some embodiments, the communication interface 4008 is not used.

It will be appreciated that computing device 4000 is illustrative and that variations and modifications are possible. A computing device can have various functionality not specifically described (e.g., voice communication via cellular telephone networks) and can include components appropriate to such functionality.

Further, while the computing device 4000 is described with reference to particular blocks, it is to be understood that these blocks are defined for convenience of description and are not intended to imply a particular physical arrangement of component parts. For example, the processing subsystem 4002, the storage subsystem 4004, the user interface 4006, and/or the communication interface 4008 can be in one device or distributed among multiple devices.

Further, the blocks need not correspond to physically distinct components. Blocks can be configured to perform various operations, e.g., by programming a processor or providing appropriate control circuitry, and various blocks might or might not be reconfigurable depending on how an initial configuration is obtained. Embodiments of the present invention can be realized in a variety of apparatus including electronic devices implemented using a combination of circuitry and software. Electronic devices described herein can be implemented using computing device 4000.

Various features described herein, e.g., methods, apparatus, computer readable media and the like, can be realized using a combination of dedicated components, programmable processors, and/or other programmable devices. Processes described herein can be implemented on the same processor or different processors. Where components are described as being configured to perform certain operations, such configuration can be accomplished, e.g., by designing electronic circuits to perform the operation, by programming programmable electronic circuits (such as microprocessors) to perform the operation, or a combination thereof. Further, while the embodiments described above may make reference to specific hardware and software components, those skilled in the art will appreciate that different combinations of hardware and/or software components may also be used and that particular operations described as being implemented in hardware might be implemented in software or vice versa.

Specific details are given in the above description to provide an understanding of the embodiments. However, it is understood that the embodiments may be practiced without these specific details. In some instances, well-known circuits, processes, algorithms, structures, and techniques may be shown without unnecessary detail in order to avoid obscuring the embodiments.

While the principles of the disclosure have been described above in connection with specific apparatus and methods, it is to be understood that this description is made only by way of example and not as limitation on the scope of the disclosure. Embodiments were chosen and described in order to explain the principles of the invention and practical applications to enable others skilled in the art to utilize the invention in various embodiments and with various modifications, as are suited to a particular use contemplated. It will be appreciated that the description is intended to cover modifications and equivalents.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc.

A recitation of “a”, “an”, or “the” is intended to mean “one or more” unless specifically indicated to the contrary. Patents, patent applications, publications, and descriptions mentioned here are incorporated by reference in their entirety for all purposes. None is admitted to be prior art.

1. An imaging system comprising:
a stage configured to hold a carrier configured to receive an analyte;
a light source configured to illuminate the analyte with an optical beam, wherein the optical beam is characterized by an optical path;
a detector configured to detect light; and
a lens system configured to focus light from the analyte on the detector after the optical beam illuminates the analyte, wherein:
the lens system is characterized by an optical axis;
the optical beam is configured to propagate through the lens system to illuminate the analyte; and
the optical path of the optical beam incident on the carrier is not parallel with the optical axis of the lens system.

2. The imaging system of claim 1, further comprising a controller configured change a distance between the carrier and the lens system, to focus light from the analyte on the detector.

3. The imaging system of claim 2, the system further comprising one or more processors configured to:
calculate a first light intensity based on light detected by a first block of pixels of the detector;
calculate a second light intensity based on light detected by a second block of pixels of the detector;
compare the first light intensity to the second light intensity to generate a focus error signal; and
control movement of the lens system in relation to the carrier based on the focus error signal.

4. The imaging system of claim 1, wherein the detector is an array detector configured to focus on a spot of light incident on the detector.

5. The imaging system of claim 4, wherein the array detector is a one-dimensional array.

6. The imaging system of claim 1, wherein the carrier comprises a flow cell, wherein the flow cell comprises a first analyte receiving surface and a second analyte receiving surface separated by a width.

7. The imaging system of claim 6, wherein a depth of focus of the lens system is smaller than the width.

8. The imaging system of claim 6, wherein the stage is configured to move so that the lens system focuses light from the first analyte receiving surface on the detector and focuses light from the second analyte receiving surface on the detector, though not simultaneously.

9. The imaging system of claim 1, wherein:
the optical beam is defined by a beam width;
the beam width is measured at the carrier; and
the beam width is equal to or less than 2 mm and/or equal to or greater than 10 microns.

10. The imaging system of claim 6, wherein the lens system comprises an immersion objective comprising a distal lens surface configured to be immersed in a fluid.

11. The imaging system of claim 10, wherein:
(a) when in a first configuration, the system is configured to image emitted radiation from analytes associated with the first analyte receiving surface, with the distal lens surface spaced by a first vertical distance from the first analyte receiving surface, the first vertical distance including a fluid segment and a substrate segment;
(b) when in a second configuration, the system is configured to image emitted radiation from analytes associated with the second analyte receiving surface, with the distal lens surface spaced by a second vertical distance from the second analyte receiving surface, the second vertical distance including fluid segments and a substrate segment; and
(c) wherein the first vertical distance is substantially the same as the second vertical distance, and wherein the fluid segment of the first vertical distance is substantially the same as the fluid segments of the second vertical distance.

12. The imaging system of claim 11, wherein the immersion objective is at least partially immersed in a reservoir on top of the first analyte receiving surface such that there is no air gap between the distal lens surface and the first analyte receiving surface.

13. The imaging system of claim 12, further comprising an x-y translation stage configured to translate one of the immersion objective or the flow cell relative to the other of the immersion objective or the flow cell during imaging and while the immersion objective is at least partially immersed in the reservoir.

14. The imaging system of claim 13, wherein the fluid in the reservoir has substantially the same index of refraction as a fluid in a fluid passageway of the flow cell between the first and second analyte receiving surfaces.

15. An imaging system, comprising:
(a) a flow cell, the flow cell comprising a first substrate including a first surface, a second substrate including a second surface, and a fluid passageway between the first surface and the second surface;
(b) an imager, the imager comprising an immersion objective, the immersion objective comprising a distal lens surface, the immersion objective at least partially immersed in a fluid;
(c) wherein, when in a first configuration, the system is configured to image emitted radiation from analytes associated with the first surface, with the distal lens surface spaced by a first vertical distance from the first surface, the first vertical distance including a fluid segment and a substrate segment;
(d) wherein, when in a second configuration, the system is configured to image emitted radiation from analytes associated with the second surface, with the distal lens surface spaced by a second vertical distance from the second surface, the second vertical distance including fluid segments and a substrate segment; and
(e) wherein the first vertical distance is substantially the same as the second vertical distance, and wherein the fluid segment of the first vertical distance is substantially the same as the fluid segments of the second vertical distance.

16. The imaging system of claim 15, further comprising a z-translation stage configured to vertically translate one of the immersion objective or the flow cell relative to the other of the immersion objective or the flow cell.

17. The imaging system of claim 15, wherein the system is configured to change from the first configuration to the second configuration by vertically translating one of the immersion objective or the flow cell relative to the other of the immersion objective or the flow cell by a distance substantially equal to a height of the fluid passageway.

18. The imaging system of claim 17, further comprising an autofocus sub-system, wherein the auto-focus sub-system is configured to focus on the first surface when the system is in the first configuration, wherein the auto-focus sub-system is configured to focus on the second surface when the system is in the second configuration.

19. The imaging system of claim 15, wherein the first surface is an interior surface of the first substrate, the second surface is an interior surface of the second substrate, and the first and second surfaces facing each other across the fluid passageway.

20. The imaging system of claim 19, further comprising a radiation source configured to stimulate emitted radiation from the analytes associated with the first and second surfaces.

21. The imaging system of claim 20, wherein the first substrate is substantially transparent to radiation from the radiation source and substantially transparent to the emitted radiation from the analytes associated with the first and second surfaces.

22. The imaging system of claim 15, wherein the immersion objective is at least partially immersed in a reservoir on top of the first substrate such that there is no air gap between the distal lens surface and the first surface of the flow cell.

23. The imaging system of claim 22, further comprising an x-y translation stage configured to translate one of the immersion objective or the flow cell relative to the other of the immersion objective or the flow cell during imaging and while the immersion objective is at least partially immersed in the reservoir.

24. The imaging system of claim 22, wherein the fluid in the reservoir has substantially the same index of refraction as a fluid in the fluid passageway.

25. An imaging system comprising:
a stage configured to hold a carrier having an analyte;
a light source configured to illuminate the analyte with an optical beam, wherein:
the carrier is configured to be attached with the stage, while the analyte is illuminated by the optical beam; and
the optical beam is characterized by an optical path;
a detector configured to detect light; and
a lens system configured to focus light from the analyte on the detector, after the optical beam illuminates the analyte, wherein:
the lens system is characterized by an optical axis;
the optical beam is configured to propagate through the lens system to illuminate the analyte; and
the optical path of the optical beam incident on the carrier is not parallel with the optical axis of the lens system.

26. The imaging system of claim 25, further comprising a controller configured change a distance between the carrier and the lens system, to focus light from the analyte on the detector.

27. The imaging system of claim 26, the system further comprising one or more processors configured to:
calculate a first light intensity based on light detected by a first block of pixels of the detector;
calculate a second light intensity based on light detected by a second block of pixels of the detector;
compare the first light intensity to the second light intensity to generate a focus error signal; and
control movement of the lens system in relation to the carrier based on the focus error signal.

28. The imaging system of claim 25, wherein the carrier is a flow cell.

29. The imaging system of claim 25, wherein the detector is an array detector configured to focus on a spot of light incident on the detector.

30. The imaging system of claim 29, wherein the array detector is a one-dimensional array.

31. The imaging system of claim 25, wherein:
the carrier comprises a first surface and a second surface; and
the first surface is separated from the second surface by a width.

32. The imaging system of claim 31, wherein a depth of focus of the lens system is smaller than the width.

33. The imaging system of claim 31, wherein:
the analyte is a first analyte;
the first analyte is attached to the first surface; and
a second analyte is attached to the second surface.

34. The imaging system of claim 33, wherein the stage is configured to move so that the lens system focuses light from the first analyte on the detector and focuses light from the second analyte on the detector, though not simultaneously.

35. The imaging system of claim 25, wherein:
the optical beam is defined by a beam width;
the beam width is measured at the carrier; and
the beam width is equal to or less than 2 mm and/or equal to or greater than 10 microns.
